(19) United States
(12) Patent Application Publication
(10) Pub. No.: US 2025/0065937 A1
(43) Pub. Date: Feb. 27, 2025

(54) Stackable push cart

(71) Applicant: Nhon Hoa Nguyen, Bankstown (AU)

(72) Inventor: Nhon Hoa Nguyen, Bankstown (AU)

(21) Appl. No.: 18/600,729

(22) Filed: Mar. 10, 2024

Related U.S. Application Data
(60) Provisional application No. 63/451,542, filed on Mar. 10, 2023.

(51) Int. Cl. B62B 3/18; B62B 3/02; B62B 3/14

(52) U.S. Cl. CPC B62B 3/18; B62B 3/02; B62B 3/1476

(57) ABSTRACT

A stackable cart for transport large panels is configured to be stackable. The stackable cart has a base frame having an open quadrilateral shape with a short side and two lateral sides coupled to the short side. The stackable cart further includes a load frame for supporting sides of the panels, and a support frame for supporting the load frame, with the load frame and the support frame coupled to the base frame. The stackable cart further includes a platform for supporting edges of the panels, with the platform including a rotatable platform, a tilt platform, or a flat platform configured to enable the stacking of the stackable cart.

The present patent application claims priority from U.S. Provisional Patent Applicant Ser. No. 63/451,542, filed on Mar. 10, 2023, entitled “Stackable push cart”, of the same inventors, hereby incorporated by reference in its entirety.

### BACKGROUND OF THE INVENTION

With the development of the mechanical and construction industry, sheet materials are more and more popular with increasingly rich and diverse sizes and designs. In order to move material sheets, prior art equipment is of large size, low flexibility, occupying a large area during transportation and storage.

FIGS. 1A-1B show a prior art push cart. FIG. 1A shows a push cart 910 having a rectangular platform 912 coupled to 4 casters 914. The casters can include swivel casters for rotating the platform. The platform is configured to support objects, such as panels, from a bottom side. The push cart also includes panel bars 912, which are coupled to the platform, and configured for side support of the panels.

FIG. 1B shows a configuration 911 for side stacking of the push carts 910. Since the platform is rectangular, each of the push carts occupies a space comparable with the size of the platform, e.g., there is no saving of space for multiple push carts. For large panels, the push cart can have a large platform, and therefore occupies a large storage area.

### SUMMARY OF THE EMBODIMENTS

In some embodiments, the present invention discloses a stackable cart for transport large panels. The stackable cart is configured to be stackable, for example, in a lateral direction. The stackable cart can be nested with other stackable carts to provide a high spacing during storage. The space saving can be greater than 50, 60, 70, 80, or even 90% as compared to a full storage of position side-by-side.

The stackable cart has a base frame constructed of beams to form an open quadrilateral shape such as an open trapezoid shape. The open quadrilateral shape has only 3 sides with a fourth side missing, for example, to form a C or U shape having segmented lines. The open quadrilateral shape can have a short side, such as a short base for a trapezoid shape, and two adjacent lateral sides connected to the short size. The long side, or a long base for a trapezoid shape, is missing, so that the three sides form an open quadrilateral shape.

Thus, the base frame can include three beams coupled together to form a 3 segmented shape, such as an open quadrilateral shape. The 3 segment base frame can include a short segment disposed between two lateral segments, e.g., a lateral segment is coupled to an end of the short segment. The lateral segments are coupled to the short segment with an angle greater than 90 degrees, so that the distance between 2 ends of the two lateral segments, e.g., the 2 ends that are not coupled to the short segment, is longer than the length of the short segment.

The open quadrilateral shape can provide an empty volume inside the quadrilateral shape defined by the 3 segments. The open quadrilateral shape with the missing side longer than the opposite short segment or side can allow the lateral stacking, e.g., the nesting of the base frame with other base frames of other stackable carts. The direction of the lateral stacking can be perpendicular to the short segment, e.g., the short segment of a next base frame that is adjacently nested to a previous base frame can be disposed in parallel with the short segment of the previous base frame. The lateral stacking can have a stack period, which is the distance between two short segments of two adjacently nested base frames, e.g., the distance between any two adjacently nested base frames (or two adjacently nested stackable carts) is the stack period.

The stack period is much less than a dimension of the stackable carts in the stacking direction. The ratio of the stack period over the cart dimension is the space that a cart uses when laterally stacked. for example, a ratio of 20% implies an 80% space saving of stackable carts.

The base frame is coupled to rotatable wheels, such as 2 wheels on the lateral segments at a front side toward the short side and 2 wheels on the lateral segments at a rear side toward the long side of the open quadrilateral shape. The rotatable wheels can be configured to roll the stackable cart. The rotatable wheels can include swivel wheels, e.g., wheels rotatable around a perpendicular axis for changing moving directions of the cart, or fixed wheels, e.g., wheels not rotatable around the perpendicular axis.

The stackable cart further includes a load frame for supporting sides of the panels. The panels can be positioned in a vertical orientation, e.g., on the edges of the panels, on the stackable cart, with the load frame providing support for the sides of the panels in the vertical orientation. The load frame can include two upward first side beams and one or more cross beams coupled to the first side beams. The first side beams can be coupled to the lateral segments of the base frame, for example, each first side beam coupled to a lateral segment, and protruded upward from the base frame. The cross beams are coupled to the two first side beams, e.g., one end of a cross beam is coupled to a first side beam. The cross beams are disposed above the base frame, and not in a volume defined by the segments of the base frame, e.g., outside of the empty volume inside the quadrilateral shape defined by the 3 segments of the base frame.

The load frame can include other cross beams, such as cross beams coupled to the one or more cross beams, for example, to secure the load frame.

The stackable cart further includes a support frame for supporting the load frame. The support frame can be coupled to the base frame and also to the load frame. For example, the support frame can include two upward second side beams. The second side beams can be coupled to the lateral segments of the base frame, for example, each second side beam coupled to a lateral segment, and protruded upward from the base frame. A first side beam and a second side beam can be coupled to a lateral segment at two separated locations so that one or both side beams are tilted. The first side beams can be disposed perpendicular to the lateral segments to form a load frame in a perpendicular plane. The second side beams can be disposed tilted to connect the lateral segments to the load frame to form a tilted support frame. Alternatively, the first and second side beams are tilted in opposite directions to form tilted load frame and support frame.

In some embodiments, the support frame can have a top second cross beam coupled to the tops of the two second side beams. The top second cross beam can be coupled to a top cross beam of the one or more cross beams of the load frame. The coupling of the top second cross beam with the top cross beam is configured to have a distance along the stack direction to be less than the stack period, to enable the stacking of the stackable cart.

The upward side beams of the load frame and/or the upward side beams of the support frame can be tilted toward the other side beams, so that the top cross beam of the load frame is coupled to the top cross beam of the support frame.

In some embodiments, the upward side beams of the support frame are coupled to the upward side beams of the load frame. For example, the top end of each upward side beam of the support frame is couple to the top end of each upward side beam of the load frame, to form an invert V shape with the 2 side beams forming two branches of the V. The upward side beams of both frames can be tilted toward each other. Alternatively, the upward side beams of one frame, such as the load frame, can be upright while the upward side beams of the other frame, such as the support frame, tilted toward the one frame.

In some embodiments, the support frame can have a second cross beam coupled to portions of the two second side beams. The second cross beam is configured so that a cross beam of the one or more first cross beams and the second cross beam closer to the short side is lower than another cross beam of the one or more first cross beams and the second cross beam. The closeness characteristic is determined characterized by a highest point on the cross beam lower than a lowest point on the another cross beam.

The stackable cart can be configured for one or more platform, such as a single platform at the front of the cart, e.g., at the short side of the base frame, a single platform at the rear of the cart, e.g., at the long side of the base frame, or a first platform at the short side and a second platform at the long side.

For example, the load frame can be positioned closer to the rear side of the base frame than the support frame. The second side beams of the support frame can be coupled to a vicinity of the front side of the base frame.

The load frame can be positioned closer to the front side of the base frame than the support frame. The second side beams of the support frame can be coupled to a vicinity of the rear side of the base frame.

The support frame can be also configured for supporting the panels. The first side beams of the load frame and the second side beams of the support frame can be coupled to portions of the lateral sides between the front side and the rear side of the base frame. A first platform can be disposed at the front side and a second platform can be disposed at the rear side.

The stackable cart further includes a platform for supporting edges of the panels, e.g., the panels can be positioned with the edges on the platform, and leaning against the load frame. The platform can be a rotatable platform, which can be rotated to an upward position from a substantially horizontal position. A horizontal position of the platform can prevent the stacking of the stackable cart, if the width of the platform is longer than the stack period. To enable the stacking, the platform can be rotated to an upward position, to reduce the horizontal distance of the platform. The upward position can form any angle beta with the vertical plane, as long as the effective horizontal distance of the platform is less than the stack period. For example, the angle beta can be less than a threshold angle having a cosine of a ratio of the width of the platform over the stack period. The platform can be rotatably coupled to the base frame or to the load frame to allow the rotation.

The rotatable platform can be configured to be rotated between an operating configuration for supporting edges of the panels and a storage configuration for stacking the stackable cart. In the operating configuration, the rotatable platform is rested against the base frame. In the storage configuration, the rotatable platform is rested against the load frame.

The rotatable platform can be positioned near the front of the platform, with the load frame positioned closer to the front side of the base frame than the support frame, and with the support frame coupled to a vicinity of the rear side of the base frame.

Two rotatable platforms can be positioned one near the front and one near the rear of the platform, with the support frame also configured for supporting the panels positioned on the rear platform.

The rotatable platform can be positioned near the rear of the platform, with the load frame positioned closer to the rear side of the base frame than the support frame, and with the support frame coupled to a vicinity of the front side of the base frame.

The platform can be a tilt platform, which can be tilted an angle alpha with the horizontal direction, such as from the load frame to prevent sliding of the panels away from the load frame. The platform can form any angle alpha with the horizontal direction, as long as the effective horizontal distance of the platform is less than the stack period. For example, the angle alpha can be greater than a threshold angle having a sine of a ratio of the width of the platform over the stack period. The summation of the angles alpha and beta is 90 degrees. The platform can be raised at the short segment portion to allow the tilting of the platform.

The tilt platform can be positioned near the front of the platform, with the load frame positioned closer to the front side of the base frame than the support frame, and with the support frame coupled to a vicinity of the rear side of the base frame.

The tilt platform can be positioned near the rear of the platform, with the load frame positioned closer to the rear side of the base frame than the support frame, and with the support frame coupled to a vicinity of the front side of the base frame.

Two platforms can be provide, with a tilt platform near the front and a rotatable platform near the rear of the platform, with the support frame also configured for supporting the panels positioned on the rear platform.

Two platforms can be provide, with a tilt platform near the front and another tilt platform near the rear of the platform, with the support frame also configured for supporting the panels positioned on the rear platform.

The platform can be a flat platform, which can be disposed on the base frame. The flat platform can have a width less than the stack period to enable the stacking of the stackable cart.

The flat platform can be positioned near the front of the platform, with the load frame positioned closer to the front side of the base frame than the support frame, and with the support frame coupled to a vicinity of the rear side of the base frame.

The flat platform can be positioned near the rear of the platform, with the load frame positioned closer to the rear side of the base frame than the support frame, and with the support frame coupled to a vicinity of the front side of the base frame.

Two platforms can be provide, with a rotatable platform near the front and a flat platform near the rear of the platform, with the support frame also configured for supporting the panels positioned on the rear platform.

Two platforms can be provide, with a tilt platform near the front and a flat platform near the rear of the platform, with the support frame also configured for supporting the panels positioned on the rear platform.

Two platforms can be provide, with a flat platform near the front and a rotatable platform near the rear of the platform, with the support frame also configured for supporting the panels positioned on the rear platform.

Two platforms can be provide, with a flat platform near the front and a tilt platform near the rear of the platform, with the support frame also configured for supporting the panels positioned on the rear platform.

Two platforms can be provide, with a first flat platform near the front and a second flat platform near the rear of the platform, with the support frame also configured for supporting the panels positioned on the rear platform. The second platform is disposed in a horizontal plane higher than a plane of the first flat platform. The second platform can include cut outs to accommodate the second upward side beams.

### BRIEF DESCRIPTION OF THE DRAWINGS

FIGS. 1A-1B show a prior art push cart.

FIGS. 2A-2D illustrate configurations of a push cart having a trapezoid base frame according to some embodiments.

FIGS. 3A-3C illustrate flow charts for forming push carts having a trapezoid base frame according to some embodiments.

FIGS. 4A-4C illustrate a configuration of a push cart for stackability according to some embodiments.

FIG. 5 illustrates a flow chart for forming a push cart configuration according to some embodiments.

FIGS. 6A-6D illustrate a configuration of a push cart having multiple cross bars according to some embodiments.

FIGS. 7A-7D illustrate configurations for cross bars of push carts according to some embodiments.

FIGS. 8A-8B illustrate flow charts for forming a push cart configuration according to some embodiments.

FIGS. 9A-9C illustrate a configuration of a push cart having a tilted whole platform according to some embodiments.

FIGS. 10A-10B illustrate a configuration of a push cart having a tilted partial platform according to some embodiments.

FIGS. 11A-11C illustrate flow charts for forming a push cart configuration according to some embodiments.

FIGS. 12A-12B illustrate a configuration of a push cart having a multi-level platform according to some embodiments.

FIGS. 13A-13C illustrate flow charts for forming a push cart configuration with a multi-level platform according to some embodiments.

FIGS. 14A-14C illustrate a configuration of a push cart having a rotatable whole platform according to some embodiments.

FIGS. 15A-15C illustrate flow charts for forming a push cart configuration with a multi-level platform according to some embodiments.

FIGS. 16A-16C illustrate a configuration of a push cart having a partial rotatable platform according to some embodiments.

FIGS. 17A-17C illustrate a configuration of a push cart having multiple partial rotatable platforms according to some embodiments.

FIGS. 18A-18C illustrate flow charts for forming a push cart configuration with a multi-level platform according to some embodiments.

FIGS. 19A-19M illustrate configurations for push carts having a rotatable platform portion according to some embodiments.

FIGS. 20A-20I illustrate configurations for push carts having a multi level platform according to some embodiments.

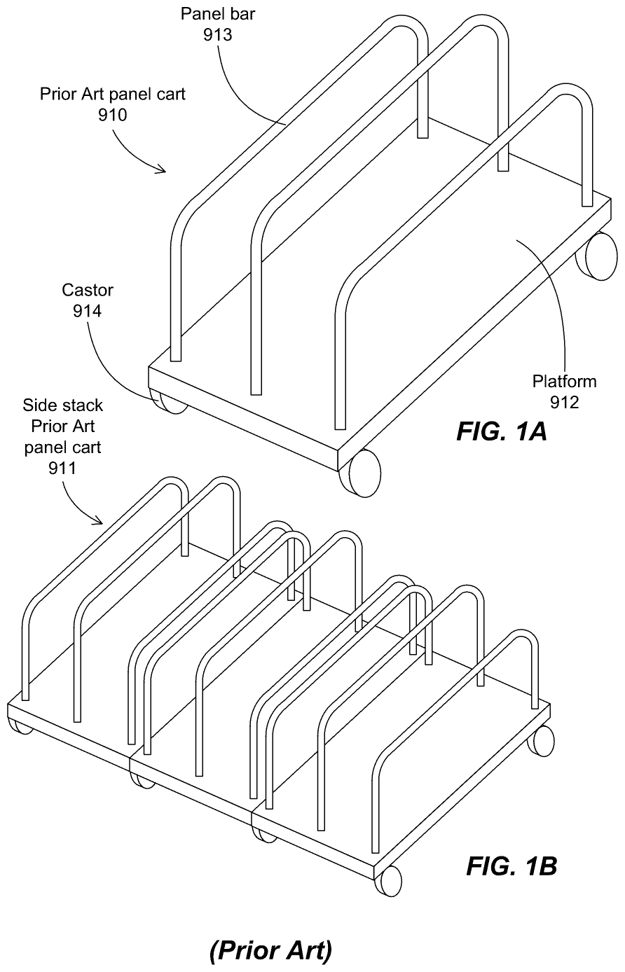

### DETAILED DESCRIPTION OF THE EMBODIMENTS

In some embodiments, the present invention discloses compact, movable push carts to move objects, such as material sheets in factory conditions or at construction sites. The push carts are configured to be more convenient during transportation and storage.

### Push Carts Having a Trapezoid Base

In some embodiments, the present invention discloses a cart, such as a push cart or motorized cart, which can be inside stacked for space saving during storage. The push cart can be hollow so that one push cart can be disposed within another push cart, which can reduce the storage footprint. For example, if a push cart can be disposed 80% into another push cart, the occupied space by 2 carts is only 1.2×, instead of 2× for cart not stored inside another cart.

The inside stack push cart is configured to be hollow, such as having a cone shape to allow inside stacking. In general, the push cart is designed so that one component of the push cart does not protrude or block, or minimally protrude or block, into another component of the push cart. For example, a horizontal plate, without carefully designed, can be detrimental for inside stacking since one end of the plate of a first push cart blocks the opposite end of a second push cart from entering the inside of the first push carts.

The push cart can include a polygon base frame, such as a quadrilateral base frame, with a missing edge. For example, the base frame of the push cart can have a trapezoid shape, with three beams forming the short base and the two lateral sides. There is no long base in the trapezoid base frame, to allow the base frame of a next push cart to enter, from the direction of the long base to the short base, the space defined by the base frame of a previous push cart. The trapezoid shape can be a parallel trapezoid, in which the long base is parallel to the short base. Alternatively, the trapezoid shape can be a non-parallel trapezoid, in which the long base is not parallel to the short base. Other polygon shapes can be used, with a missing long side to allow inside stacking.

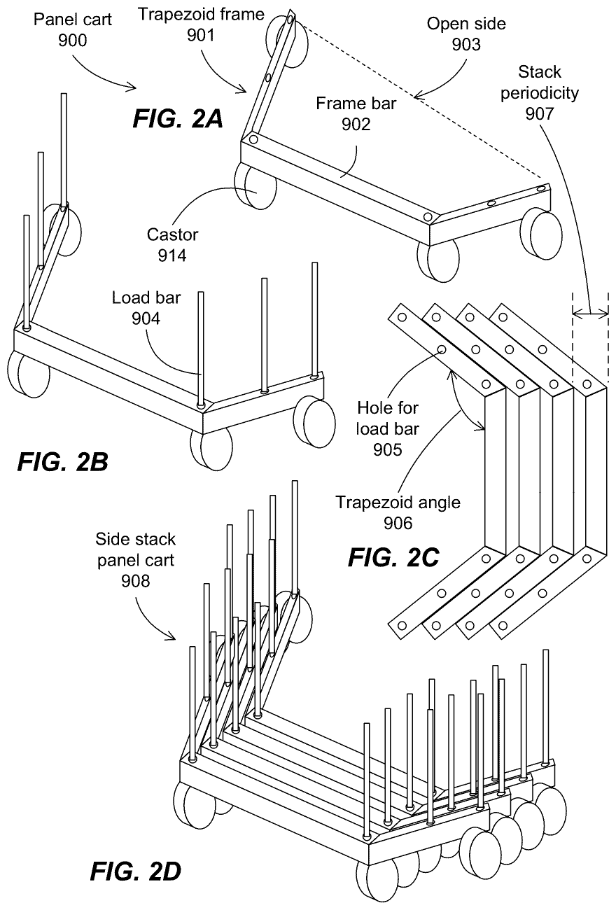

FIGS. 2A-2D illustrate configurations of a push cart having a trapezoid base frame according to some embodiments. FIG. 2A shows a push cart or a panel cart 900 having a trapezoid base frame 901 having three frame bars 902 forming three sides of the trapezoid. There is no beam in the fourth side 903, e.g., there is an open side 903 for the base frame 901. Casters 914 are coupled to the base frame, such as to the three frame bars, for moving the push cart. The frame bars 902 can include holes 905 or couplers for attaching load bars 904, for example, to support the sides of the panels. Alternatively, the load bars can be fixedly coupled to the frame bars. During operation, a panel to be transported can be positioned on the frame bars, and side supported by the load bars.

FIG. 2B shows the push cart with load bars 904 coupled to a trapezoid base frame 901. The load bars are disposed vertically, e.g., straight up from the frame bars 902. In this configuration, the push cart forms a hollow space accessible from the open side 903, which can allow another push cart to enter for storage purpose.

FIG. 2C shows a top view of a stack of push carts. The base frames are disposed next to each other, with a base frame disposed within a space formed by an adjacent base frame. The storage space occupied by multiple push carts is much less than the multiplicity of space occupied by the multiple push carts.

A trapezoid base frame is shown, with the sides forming an angle 906 with the short base. The angle 906 is related to a stack periodicity 907, which is the distance separating two push carts in storage position. Within the stack periodicity, components of the push cart can be positioned without affecting the inside stack characteristics, since the outside push cart does not enter the space defined by the stack periodicity.

FIG. 2D shows a perspective view of a stack of push carts. An inside stack 908 of 4 push carts is shown to occupy a much less space than 4× the size of each push cart. As shown, the push carts have a trapezoid base frame with an open side, together with multiple load bars disposed vertically from the frame bars of the trapezoid base frame.

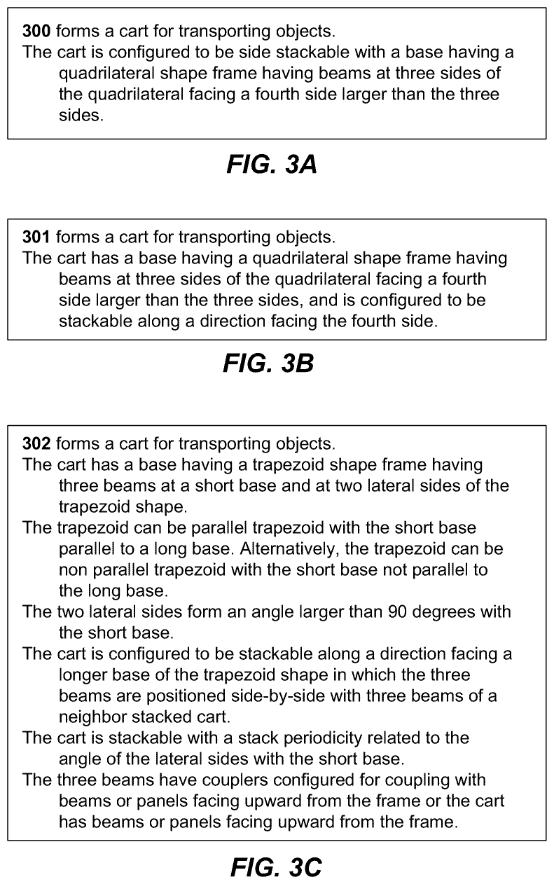

FIGS. 3A-3C illustrate flow charts for forming push carts having a trapezoid base frame according to some embodiments. In FIG. 3A, operation 300 forms a cart for transporting objects. The cart is configured to be side stackable within each other, e.g., inside stackable, due to having a base having a quadrilateral shape frame, such as a trapezoid frame. The frame has beams at three sides of the quadrilateral, e.g., a short base and two sides of the trapezoid, facing an open fourth side larger than the three sides.

In FIG. 3B, operation 301 forms a cart for transporting objects. The cart has a base having a quadrilateral shape frame having beams at three sides of the quadrilateral facing an open fourth side larger than the three sides, and is configured to be stackable along a direction facing the fourth side. The carts enter each other from the fourth side.

In FIG. 3C, operation 302 forms a cart for transporting objects. The cart has a base having a trapezoid shape frame having three beams at a short base and at two lateral sides of the trapezoid shape.

The trapezoid can be a parallel trapezoid with the short base parallel to a long base. The long base is open, e.g., there is no beam at the long base. Alternatively, the trapezoid can be a non parallel trapezoid with the short base not parallel to the long base.

The two lateral sides form an angle larger than 90 degrees with the short base to allow the base frame of one push cart to enter the space defined by a base frame of another push cart. The cart is configured to be stackable along a direction facing a longer base of the trapezoid shape in which the three beams are positioned side-by-side with three beams of a neighbor stacked cart.

The cart is stackable with a stack periodicity related to the angle of the lateral sides with the short base.

The three beams have couplers, such as holes, configured for coupling with beams or panels facing upward from the frame. Alternatively, the cart has beams or panels facing upward from the frame.

### Push Carts Having a Cross Panel

For push carts with inside stackability, no component of the push cart can be located away from an existing component, along the stack direction, at a distance greater than the stack periodicity. The reason is that the new component can interfere with the stacking process.

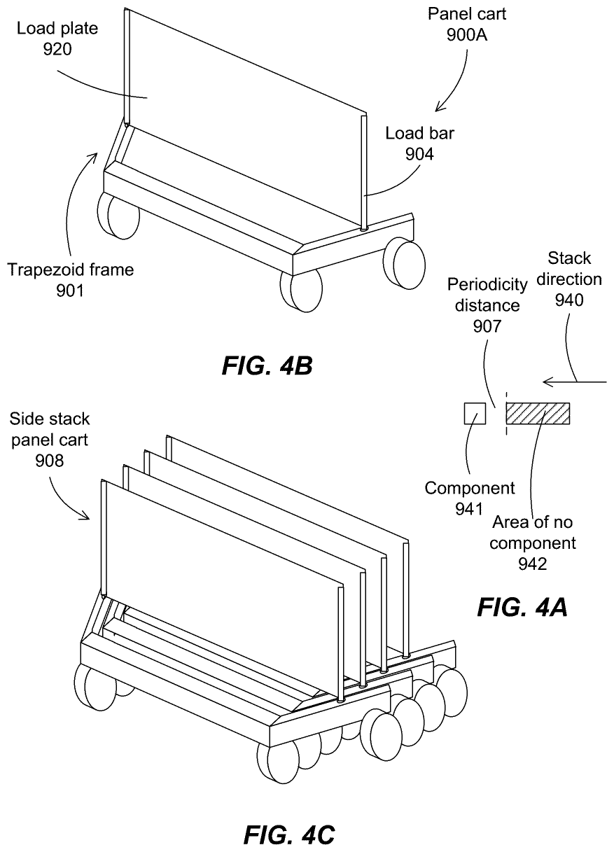

FIGS. 4A-4C illustrate a configuration of a push cart for stackability according to some embodiments. In FIG. 4A, a requirement for the inside stackability of push carts is shown. A push cart can have an existing component 941, such as a frame bar or a load bar. In a same horizontal plane, there is no component of the push cart at the area 942, which is located at a stack periodicity distance 907 from the existing component 941 in the direction 940 of stacking. The periodicity distance is calculated from a farthest point of the existing component.

In an operation of stacking, a new push cart is pushed in the stack direction 940 toward an existing push cart. The existing push cart has an existing component 941. The new push cart also has a component corresponded with the existing component. If the existing push cart has another component in the no-component area 942, the corresponded component would be blocked by the another component.

FIG. 4B shows a push cart 900A having a trapezoid frame 901, together with load bars 904 and a load panel 920. The load panel is disposed above the trapezoid frame, so that the area defined by the trapezoid frame is free from having any component. Also there is no component separated from the load panel in the stacking direction. Thus, the push cart 900A can be inside stacked.

FIG. 4C shows a stack 908 of push carts 900A. As shown, there is no component blocking the stacking of the trapezoid frame 901 and the load panel 920.

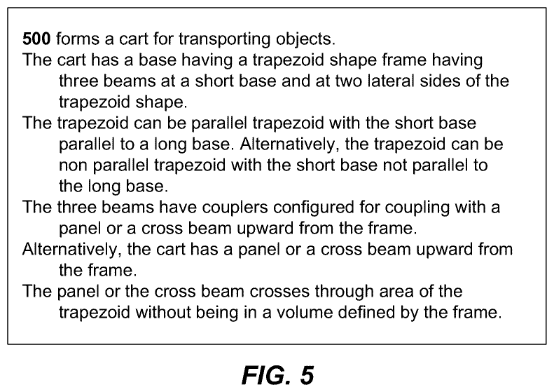

FIG. 5 illustrates a flow chart for forming a push cart configuration according to some embodiments. Operation 500 forms a cart for transporting objects. The cart has a base having a trapezoid shape frame having three beams at a short base and at two lateral sides of the trapezoid shape. The trapezoid can be parallel trapezoid with the short base parallel to a long base. Alternatively, the trapezoid can be non parallel trapezoid with the short base not parallel to the long base.

The three beams of the trapezoid frame have couplers configured for coupling with a panel or a cross beam upward from the frame. Alternatively, the cart has a panel or a cross beam upward from the frame. The panel or the cross beam crosses through area of the trapezoid without being in a volume defined by the frame.

### Push Carts Having Multiple Cross Bar

For push carts having multiple cross bars, e.g., bars that are not perpendicular to the trapezoid base frame, the successive cross bars in the direction of stackability (from the short base to the open long base of the trapezoid base frame) are successively disposed at higher planes. If the successive cross bars are disposed at a same plane, the first bar of the next push cart would interfere with the later horizontal bars of the previous push cart.

If the successive cross bars are disposed at successively lower planes, the horizontal first bar of the next push cart is clear with the later bars of the previous push cart, since they are not at a same horizontal plane. However, the vertical bars that are used to support the horizontal first cross bar would interfere with the later horizontal bars of the previous push cart

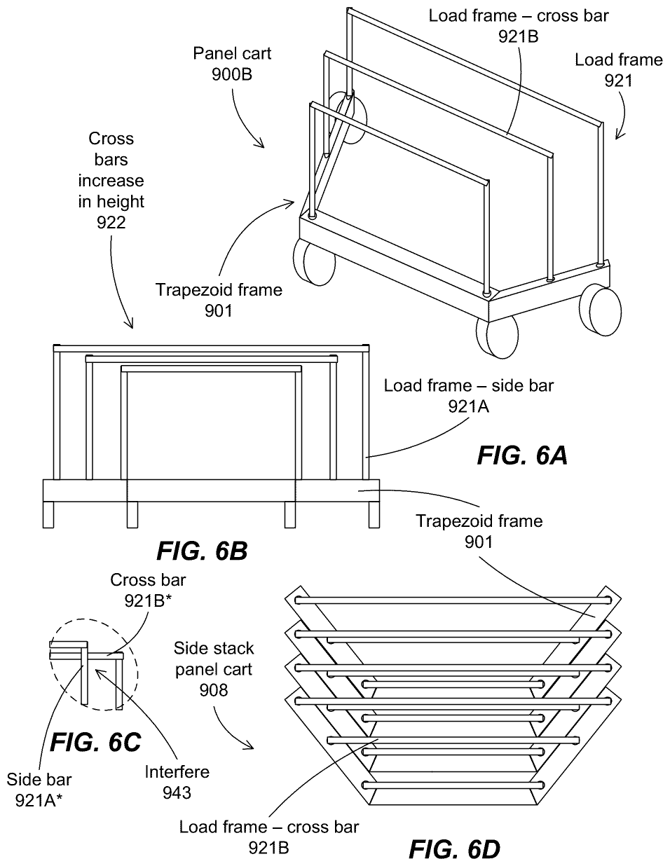

FIGS. 6A-6D illustrate a configuration of a push cart having multiple cross bars according to some embodiments. In FIG. 6A, a push cart 900B is shown, having a trapezoid frame 901 with multiple load frames 921. Each load frame 921 has a cross bar 921B coupled to two side bars 921A. As shown, the cross bar 921B is disposed horizontally, and the side bars are disposed vertically. Other configurations can be used, such as side bars tilted non-vertically toward or away from the trapezoid frame, or cross bars tilted non-horizontally.

FIG. 6B shows a front view of the push cart 900B, showing the cross bars 921B with successive heights 922, e.g., the cross bars are at a higher elevation toward the open side from the short side of the trapezoid frame. As such, the lowest load frame, e.g., the load frame having two side bars and a lowest cross bar, of a next push cart would be cleared of the other load frames, e.g., cross bars and side bars, of the existing push cart.

If the cross bars having a same height, the lowest load frame of a next push cart would interfere with the cross bars of the other load frames of the existing push cart.

If the cross bars having a successively lower heights, the lowest load frame of a next push cart, e.g., the side bars 921A* of the lowest load frame, would interfere 943 with the other load frames, e.g., the cross bar 921B* of the other load frames, of the existing push cart (FIG. 6C).

FIG. 6D shows a stack 908 of push carts 900B, with the cross bars cleared of each other in the stack configuration.

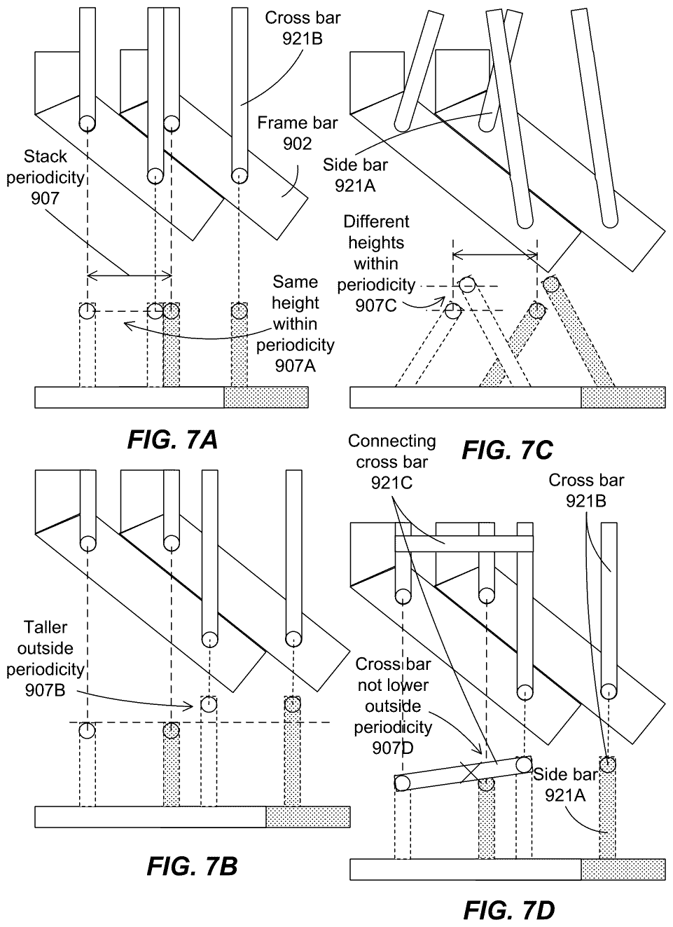

FIGS. 7A-7D illustrate configurations for cross bars of push carts according to some embodiments. FIG. 7A shows a configuration in which two cross bars coupled to frame bars 902 having a same height 907A within a stack periodicity distance 907. The top image shows a top view, and the bottom image shows a front view. The corresponded cross bars of the next push cart would be disposed next to the previous cart, without any interference. The cross bars 921B are shown as bars in the top view, and shown as circles in the front view. The side bars 921A are shown as bars in the front view, and shown as circles in the top view.

FIG. 7B shows a configuration in which two cross bars coupled to frame bars 902 having different heights 907B outside of the stack periodicity distance 907 with the cross bar to the right toward the open side of then trapezoid frame taller. The top image shows a top view, and the bottom image shows a front view. The lower cross bars of the next push cart would move pass the higher cross bar of the previous cart, without any interference. The cross bars are shown as bars in the top view, and shown as circles in the front view. The side bars are shown as bars in the front view, and shown as circles in the top view.

FIG. 7C shows a configuration in which two cross bars coupled to frame bars 902 having different heights 907C within the stack periodicity distance 907 with the cross bar to the right toward the open side of then trapezoid frame taller. The top image shows a top view, and the bottom image shows a front view. The lower cross bars of the next push cart would move pass the higher cross bar of the previous cart, without any interference. The cross bars are not shown in the top view, and shown as circles in the front view. The side bars are shown as bars in the front view, and also shown as bars in the top view.

FIG. 7D shows a configuration in which two cross bars coupled to frame bars 902 having different heights 907D outside of the stack periodicity distance 907 with the cross bar to the right toward the open side of then trapezoid frame taller. There are connecting bars 921C connecting the cross bars 921B. The top image shows a top view, and the bottom image shows a front view. The cross bars are shown as bars in the top view, and shown as circles in the front view. The side bars are shown as bars in the front view, and shown as circles in the top view.

The lower cross bars of the next push cart would interfere with the connecting cross bar of the previous cart, since the connecting cross bar 921C has a portion duplicating of an existing portion on the lowest side bar.

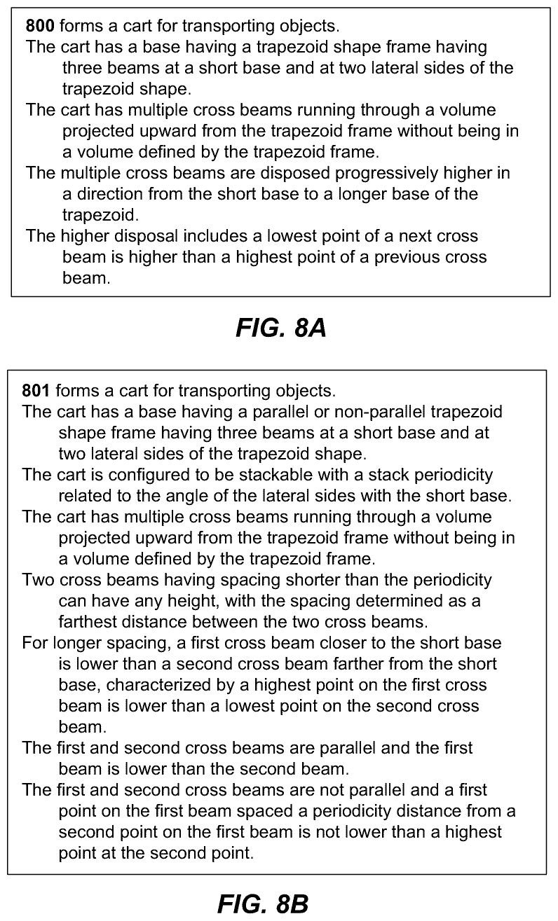

FIGS. 8A-8B illustrate flow charts for forming a push cart configuration according to some embodiments. In FIG. 8A, operation 800 forms a cart for transporting objects. The cart has a base having a trapezoid shape frame having three beams at a short base and at two lateral sides of the trapezoid shape.

The cart has multiple cross beams running through a volume projected upward from the trapezoid frame without being in a volume defined by the trapezoid frame. The multiple cross beams are disposed progressively higher in a direction from the short base to a longer base of the trapezoid. The higher disposal includes a lowest point of a next cross beam is higher than a highest point of a previous cross beam.

In FIG. 8B, operation 801 forms a cart for transporting objects. The cart has a base having a parallel or non-parallel trapezoid shape frame having three beams at a short base and at two lateral sides of the trapezoid shape. The cart is configured to be stackable with a stack periodicity related to the angle of the lateral sides with the short base.

The cart has multiple cross beams running through a volume projected upward from the trapezoid frame without being in a volume defined by the trapezoid frame. Two cross beams having spacing shorter than the periodicity can have any height, with the spacing determined as a farthest distance between the two cross beams. For longer spacing, a first cross beam closer to the short base is lower than a second cross beam farther from the short base, characterized by a highest point on the first cross beam is lower than a lowest point on the second cross beam.

The first and second cross beams are parallel and the first beam is lower than the second beam. The first and second cross beams are not parallel and a first point on the first beam spaced a periodicity distance from a second point on the first beam is not lower than a highest point at the second point.

### Push Carts Having Tilt Platform

A horizontal platform can present a problem for push cart inside stackability, due to the interference of the platform of a next push cart on the existing platform. To achieve inside stackability, a tilted platform can be used, for example, with the platform portion nearer the open side of the trapezoid frame being at a higher height as compared to a platform portion nearer the short base. As such, the whole platform or a portion of the platform can be tilted, for example, at an end of the platform near the short base or at a middle portion of the platform.

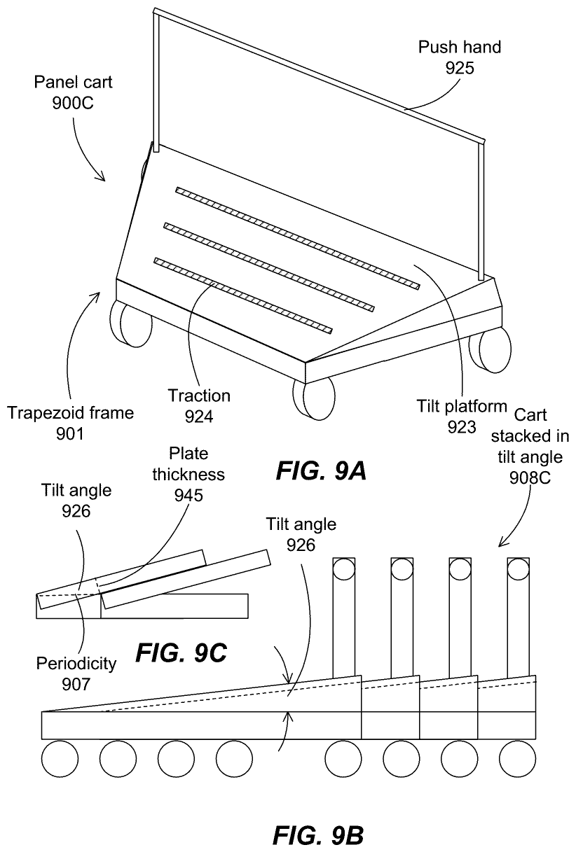

FIGS. 9A-9C illustrate a configuration of a push cart having a tilted whole platform according to some embodiments. In FIG. 9A, a push cart 900C is shown, having a trapezoid frame 901 with a tilted platform 923 for a tilt angle 926, and a push hand handle 925. The tilted platform can include an adhesive top surface or one or more adhesive lines 924 to increase friction on the platform top surface.

FIG. 9B shows a stack 908C of push carts 900C, with the tilted platform of one push cart disposed under the tilted platform of an adjacent push cart.

FIG. 9C shows a calculation for a titled angle. The tilted angle of the platform is greater than a minimum angle configured to provide clearance for a next cart at the stack periodicity distance. For example, the minimum angle can be the arcsine of the ratio of the platform plate thickness 945 over the stack periodicity distance 907. For a platform thickness of a few millimeters, such as 5 mm, and a stack periodicity distance of a few centimeters, such as 20 mm, the titled angle can be around 5 degrees. In general, the tilted angle can be greater than 10 degrees, less than 8, 6, 5, or 4 degrees.

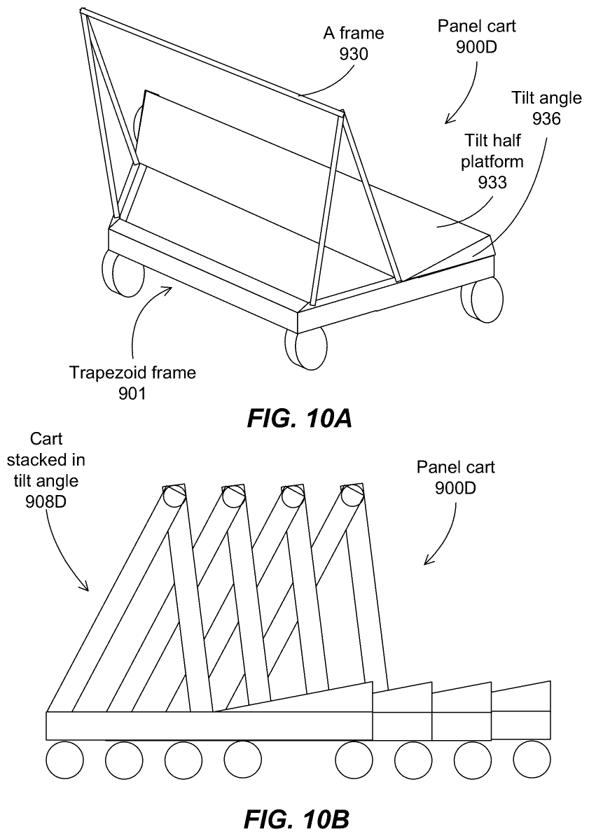

FIGS. 10A-10B illustrate a configuration of a push cart having a tilted partial platform according to some embodiments. In FIG. 9A, a push cart 900D is shown, having a trapezoid frame 901 with a tilted partial platform 933, and an A frame 930.

FIG. 10B shows a stack 908D of push carts 900D, with the tilted platform of one push cart disposed under the tilted platform of an adjacent push cart.

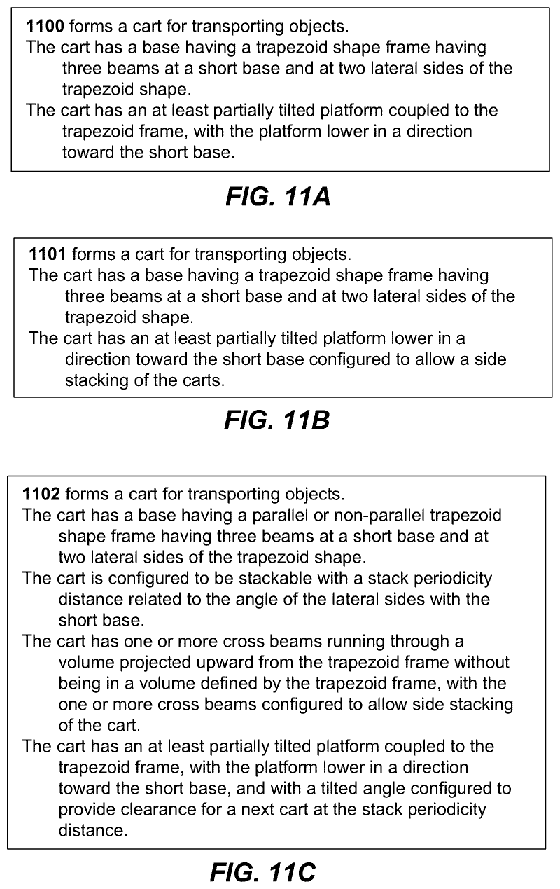

FIGS. 11A-11C illustrate flow charts for forming a push cart configuration according to some embodiments. In FIG. 11A, operation 1100 forms a cart for transporting objects. The cart has a base having a trapezoid shape frame having three beams at a short base and at two lateral sides of the trapezoid shape.

The cart has an at least partially tilted platform coupled to the trapezoid frame, with the platform lower in a direction toward the short base.

In FIG. 11B, operation 1101 forms a cart for transporting objects. The cart has a base having a trapezoid shape frame having three beams at a short base and at two lateral sides of the trapezoid shape.

The cart has an at least partially tilted platform lower in a direction toward the short base configured to allow a side stacking of the carts.

In FIG. 11C, operation 1102 forms a cart for transporting objects. The cart has a base having a parallel or non-parallel trapezoid shape frame having three beams at a short base and at two lateral sides of the trapezoid shape.

The cart is configured to be stackable with a stack periodicity distance related to the angle of the lateral sides with the short base. The cart has one or more cross beams running through a volume projected upward from the trapezoid frame without being in a volume defined by the trapezoid frame, with the one or more cross beams configured to allow side stacking of the cart.

The cart has an at least partially tilted platform coupled to the trapezoid frame, with the platform lower in a direction toward the short base, and with a tilted angle configured to provide clearance for a next cart at the stack periodicity distance.

### Push Carts Having Multiple Level Platform

A push cart with inside stackability can include a multiple level platform, e.g., a platform with more than one surface level, such as 2 surfaces forming a step. For example, a platform can have two portions, with one portion near the open side, e.g., the long base of the trapezoid frame, being at a higher elevation as compared to another portion near the short base.

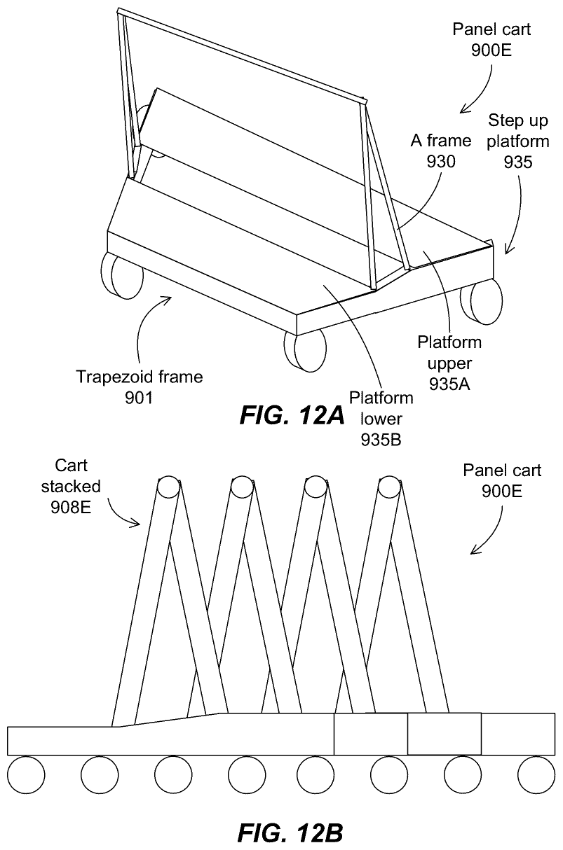

FIGS. 12A-12B illustrate a configuration of a push cart having a multi-level platform according to some embodiments. In FIG. 12A, a push cart 900H is shown, having a trapezoid frame 901 with a step up platform 935 having an upper portion 935A and a lower portion 935B, and an A frame 930 between the two platform portions.

FIG. 12B shows a stack 908H of push carts 900C, with the tilted platform of one push cart disposed under the tilted platform of an adjacent push cart.

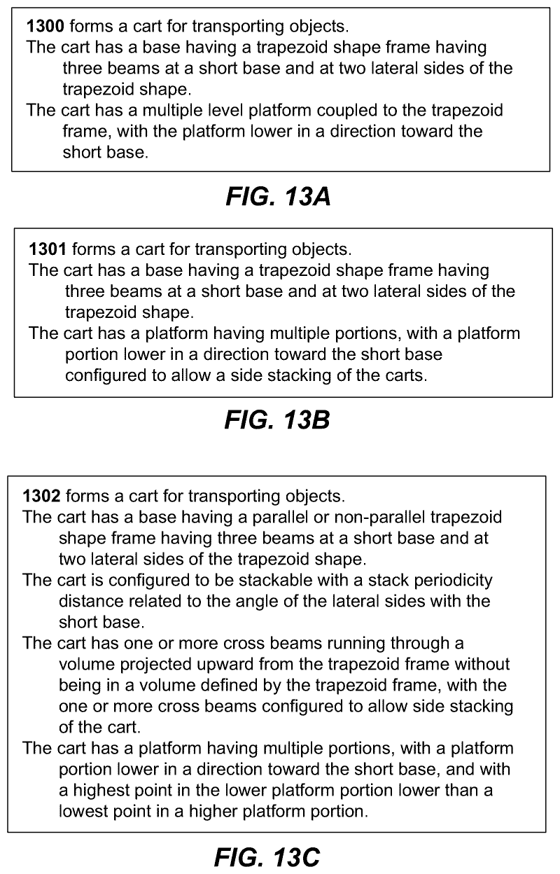

FIGS. 13A-13C illustrate flow charts for forming a push cart configuration with a multi-level platform according to some embodiments. In FIG. 13A, operation 1300 forms a cart for transporting objects. The cart has a base having a trapezoid shape frame having three beams at a short base and at two lateral sides of the trapezoid shape.

The cart has a multiple level platform coupled to the trapezoid frame, with the platform lower in a direction toward the short base.

In FIG. 13B, operation 1301 forms a cart for transporting objects. The cart has a base having a trapezoid shape frame having three beams at a short base and at two lateral sides of the trapezoid shape.

The cart has a platform having multiple portions, with a platform portion lower in a direction toward the short base configured to allow a side stacking of the carts.

In FIG. 13C, operation 1302 forms a cart for transporting objects. The cart has a base having a parallel or non-parallel trapezoid shape frame having three beams at a short base and at two lateral sides of the trapezoid shape.

The cart is configured to be stackable with a stack periodicity distance related to the angle of the lateral sides with the short base.

The cart has one or more cross beams running through a volume projected upward from the trapezoid frame without being in a volume defined by the trapezoid frame, with the one or more cross beams configured to allow side stacking of the cart.

The cart has a platform having multiple portions, with a platform portion lower in a direction toward the short base, and with a highest point in the lower platform portion lower than a lowest point in a higher platform portion.

### Push Carts Having Rotatable Platform

A tilted platform can be used to achieve inside stackability. A push cart having a tilt platform is suitable for transporting panels, but the tilted platform push cart is not desirable for low friction objects, since the objects can roll or slide down the slope,

A movable, such as rotatable, platform can be used in the push carts, with the movable platform push carts can have a horizontal platform during operation and a tilted platform during storage. The movable platform can include a linear translation to move the platform up and down, or a rotatable platform to tilt the platform around a hinge assembly on a portion of the trapezoid frame.

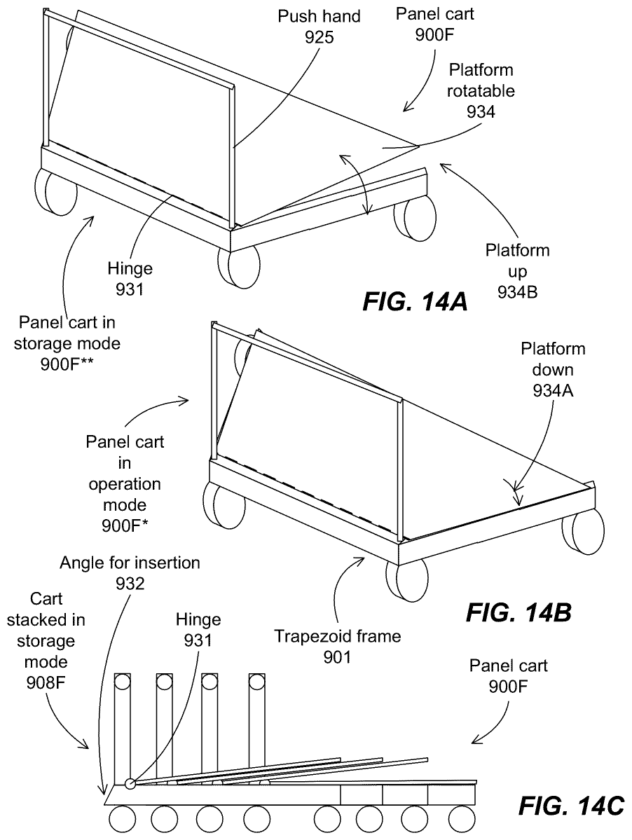

FIGS. 14A-14C illustrate a configuration of a push cart having a rotatable whole platform according to some embodiments. A push cart 900F can have a trapezoid frame 901 with a rotatable platform 934, and a push hand handle 925. The rotatable platform is coupled to the trapezoid frame using a hinge assembly, such as two hinges at two sides of the platform, or a piano hinge 931 along an edge or side of the platform. The platform can rest on the trapezoid frame on the lateral sides of the trapezoid. With the hinge assembly, the platform can be tilted a tilt angle for storage, or can be horizontal for transporting objects.

FIG. 14A shows the push cart 900F in storage mode 900F** with the platform tilted 934B an angle for inserting a next push cart. In operation, the rotation of the platform can be automatic. For example, the push cart can have an angle 932, e.g., having a slope at an end of the trapezoid frame, e.g., at the hinge portion, for lifting the platform of the existing push cart when the next push cart is inserted in the trapezoid frame of the existing push cart.

As shown, the push hand handle 925 is disposed at the short base of the trapezoid frame. Alternatively, the push hand handle 925 is disposed at the open side, e.g., the (not present) long base of the trapezoid frame. The poles of the push hand handle can be disposed on the lateral sides.

As shown, the hinge assembly 931 is disposed at the short base of the trapezoid frame, in the form of a piano hinge. Alternatively, the hinge assembly can include two rotatable couplers for connecting the platform with two ends of the short base, or with two ends of the two lateral sides of the trapezoid frame.

FIG. 14B shows the push cart 900F in operation mode 900F* with the platform resting 934A on the trapezoid frame, e.g., the platform being horizontal for ease of carrying objects. In operation, the rotation of the platform can be automatic. For example, the push cart, in a stack of push carts, can be pulled out of the stack, for example, by pushing on the push hand handle. After the push cart is removed from the stack, the platform is lowered due to gravity.

FIG. 14C shows a stack 908F of push carts 900F, with the platform of one push cart rotated up to accommodate an adjacent push cart.

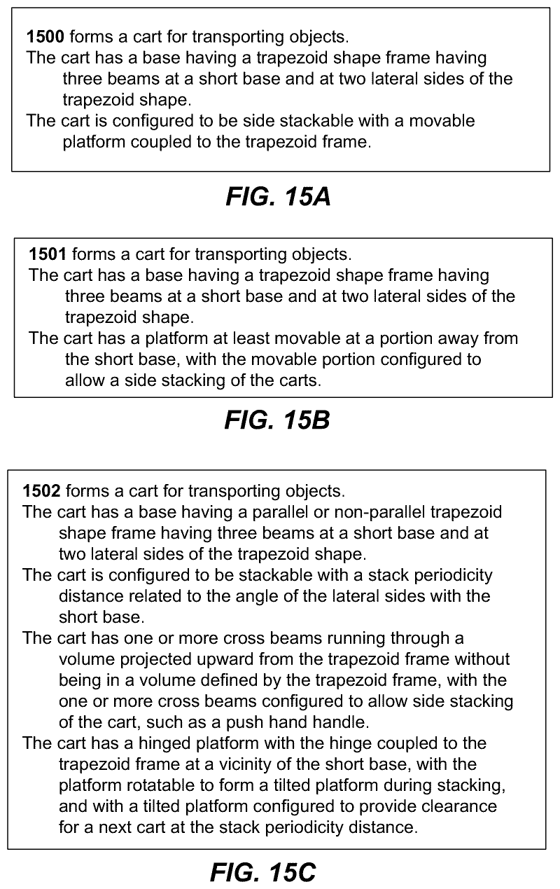

FIGS. 15A-15C illustrate flow charts for forming a push cart configuration with a multi-level platform according to some embodiments. In FIG. 15A, operation 1500 forms a cart for transporting objects. The cart has a base having a trapezoid shape frame having three beams at a short base and at two lateral sides of the trapezoid shape. The cart is configured to be side stackable with a movable platform coupled to the trapezoid frame.

In FIG. 15B, operation 1501 forms a cart for transporting objects. The cart has a base having a trapezoid shape frame having three beams at a short base and at two lateral sides of the trapezoid shape. The cart has a platform at least movable at a portion away from the short base, with the movable portion configured to allow a side stacking of the carts.

In FIG. 15C, operation 1502 forms a cart for transporting objects. The cart has a base having a parallel or non-parallel trapezoid shape frame having three beams at a short base and at two lateral sides of the trapezoid shape. The cart is configured to be stackable with a stack periodicity distance related to the angle of the lateral sides with the short base.

The cart has one or more cross beams running through a volume projected upward from the trapezoid frame without being in a volume defined by the trapezoid frame, with the one or more cross beams configured to allow side stacking of the cart, such as a push hand handle.

The cart has a hinged platform with the hinge coupled to the trapezoid frame at a vicinity of the short base, with the platform rotatable to form a tilted platform during stacking, and with a tilted platform configured to provide clearance for a next cart at the stack periodicity distance.

### Push Carts Having Partial Rotatable Platform

A platform can cover the entire surface of the trapezoid base frame. Alternatively, the platform can cover only one portion of the trapezoid surface, such as a portion from the short base to half of the lateral sides. The portion platform can be rotated from the short base, or from the middle of the trapezoid.

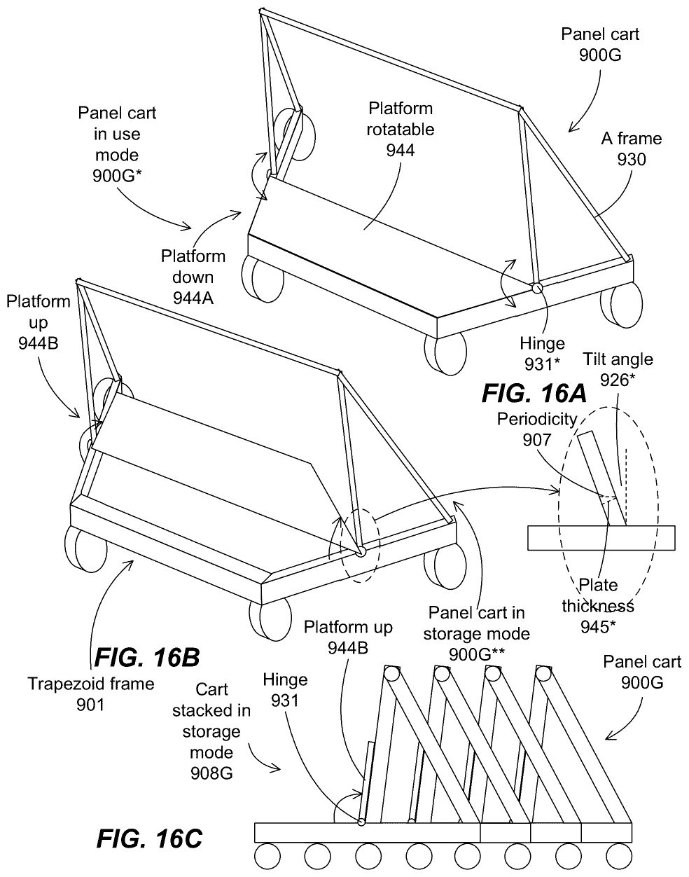

FIGS. 16A-16C illustrate a configuration of a push cart having a partial rotatable platform according to some embodiments. A push cart 900G can have a trapezoid frame 901 with a rotatable platform 944, and an A frame 930. The rotatable platform 944 covers only a portion of the surface of the trapezoid frame, such as from the short base to half of the lateral sides. The partial platform is coupled to the trapezoid frame using a hinge assembly, such as two hinges 931* at two sides of the platform (e.g., on the lateral sides), or a piano hinge along an edge or side of the platform. The platform can rest on the trapezoid frame on the lateral sides of the trapezoid. With the hinge assembly, the platform can be tilted a tilt angle for storage, or can be horizontal for transporting objects.

FIG. 16A shows the push cart 900G in operation mode 900G* with the platform lowered 944A. As shown, the platform is horizontal. Alternatively, the platform can be tilted a small angle, such as a few degrees, e.g., less than 10, 8, 6, or 4 degrees, for added stability to the transport panels. For example, the panels can be disposed on the platform, and supported by the A frame. A tilted platform can reduce the probability that the panels fall by rotating against the A frame.

In operation, the rotation of the platform can be manual or automatic. For example, the push cart, in a stack of push carts, can be pulled out of the stack, for example, by pulling on the A frame. After the push cart is removed from the stack, the position of the platform is adjusted to suit the transport need, such as lowering the platform by an operator.

As shown, the A frame 930 is disposed at the open side of the trapezoid frame. Alternatively, the A frame 930 can be disposed at the short base of the trapezoid frame. The poles of the A frame 930 can be disposed on the lateral sides.

As shown, the hinge assembly 931 includes two hinges or rotatable couplers disposed on a middle portion of each lateral side. Alternatively, the hinge assembly can include a piano hinge running across the lateral sides.

FIG. 16B shows the push cart 900G in storage mode 900G** with the platform raised up toward the A frame. The rotation of the platform can be manual or automatic. Alternatively, the platform can be partially raised up, or can be horizontal.

The tilt angle 926* of the platform can be calculated to allow stacking of the push cart. The tilted angle of the platform can be less than a maximum angle configured to provide clearance for a next cart at the stack periodicity distance. For example, the maximum angle can be the arccosine of the ratio of the platform plate thickness 945* over the stack periodicity distance 907.

FIG. 16C shows a stack 908G of push carts 900G, with the platform of one push cart rotated up to accommodate an adjacent push cart.

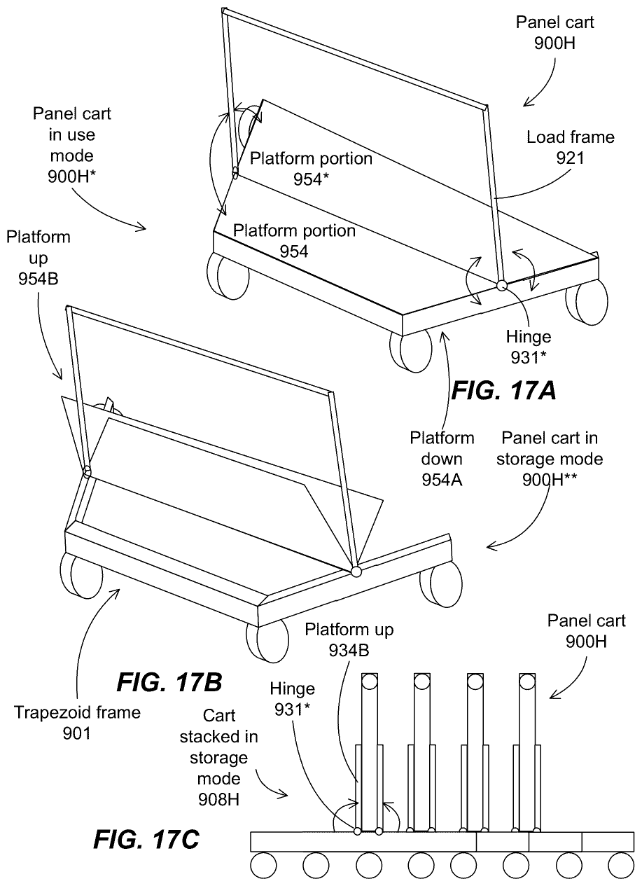

FIGS. 17A-17C illustrate a configuration of a push cart having multiple partial rotatable platforms according to some embodiments. A push cart 900G can have a trapezoid frame 901 with a first rotatable platform portion 954 and a second rotatable platform portion 954*, and a load frame 921. The two rotatable platform portions 954 and 954* cover the whole surface of the trapezoid frame. Alternatively, the two rotatable platform portions can cover only a portion of the trapezoid surface.

The platform portions are coupled to the trapezoid frame using a hinge assembly, such as two hinges 931* at two sides of each platform portion, or piano hinges along an edge or side of the platform portions.

FIG. 17A shows the push cart 900H in operation mode 900H* with the platform lowered 954A. As shown, the platform is horizontal. Alternatively, the platform can be tilted a small angle, such as a few degrees, e.g., less than 10, 8, 6, or 4 degrees, for added stability to the transport panels. For example, the panels can be disposed on the platform, and supported by the load frame. A tilted platform can reduce the probability that the panels fall by rotating against the load frame.

FIG. 17B shows the push cart 900H in storage mode 900H** with the platform raised up toward the A frame. The rotation of the platform can be manual or automatic. Alternatively, the platform can be partially raised up, or can be horizontal.

FIG. 17C shows a stack 908H of push carts 900H, with the platform of one push cart rotated up to accommodate an adjacent push cart.

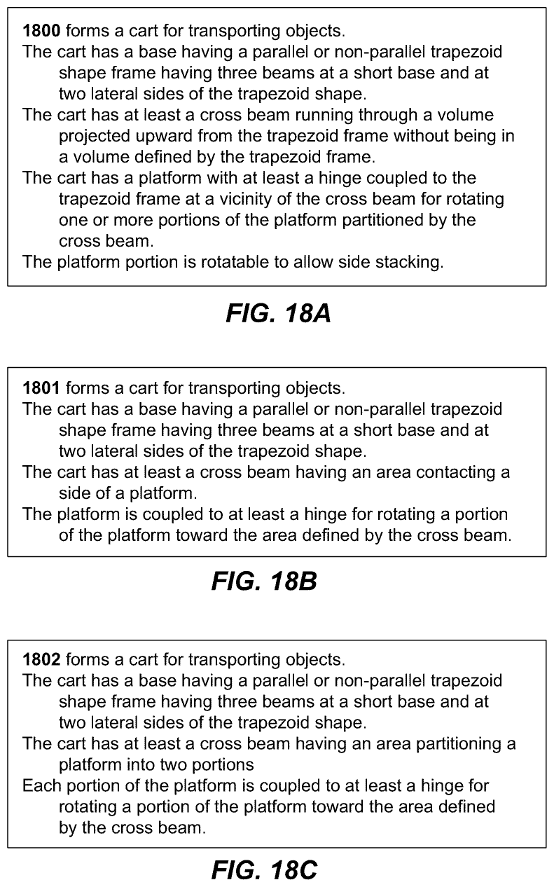

FIGS. 18A-18C illustrate flow charts for forming a push cart configuration with a multi-level platform according to some embodiments. In FIG. 18A, operation 1800 forms a cart for transporting objects. The cart has a base having a parallel or non-parallel trapezoid shape frame having three beams at a short base and at two lateral sides of the trapezoid shape.

The cart has at least a cross beam running through a volume projected upward from the trapezoid frame without being in a volume defined by the trapezoid frame. The cart has a platform with at least a hinge coupled to the trapezoid frame at a vicinity of the cross beam for rotating one or more portions of the platform partitioned by the cross beam.

The platform portion is rotatable to allow side stacking.

In FIG. 18B, operation 1801 forms a cart for transporting objects. The cart has a base having a parallel or non-parallel trapezoid shape frame having three beams at a short base and at two lateral sides of the trapezoid shape.

The cart has at least a cross beam having an area contacting a side of a platform. The platform is coupled to at least a hinge for rotating a portion of the platform toward the area defined by the cross beam.

In FIG. 18C, operation 1802 forms a cart for transporting objects. The cart has a base having a parallel or non-parallel trapezoid shape frame having three beams at a short base and at two lateral sides of the trapezoid shape.

The cart has at least a cross beam having an area partitioning a platform into two portions. Each portion of the platform is coupled to at least a hinge for rotating a portion of the platform toward the area defined by the cross beam.

In some embodiments, the present invention discloses a stackable push cart with a rotatable partial platform.

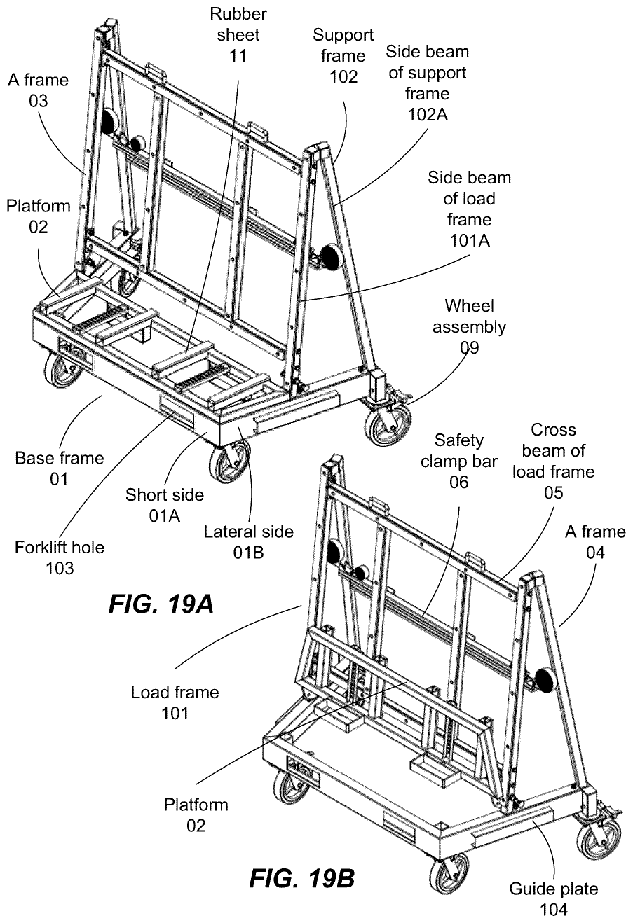

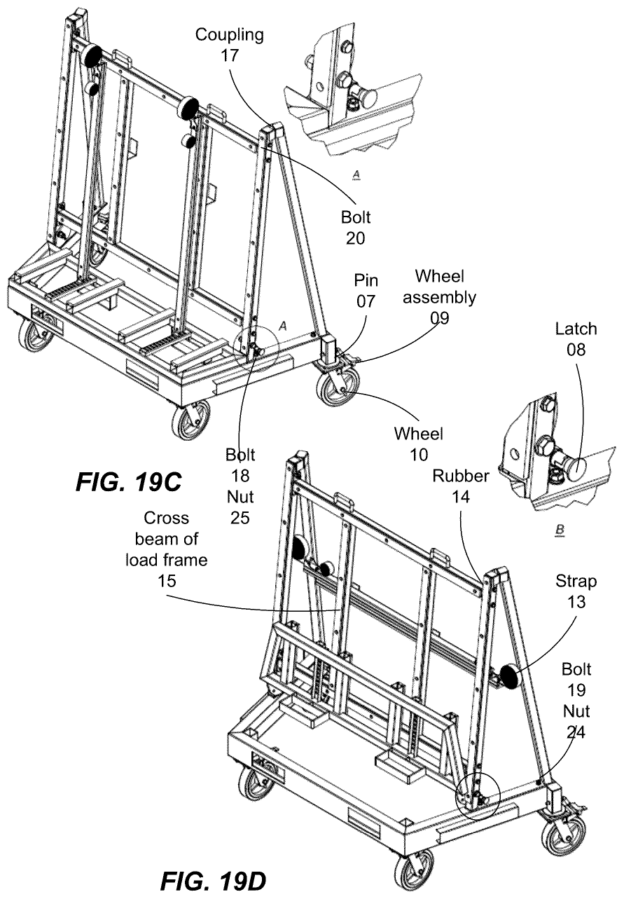

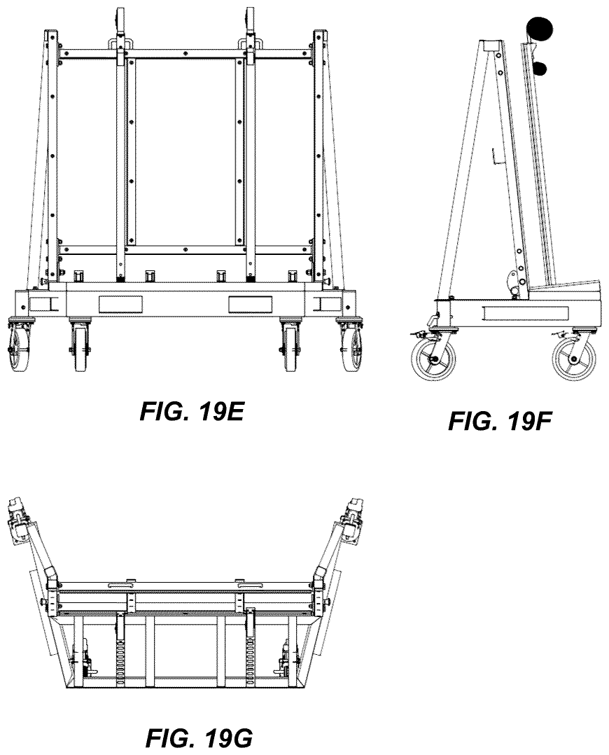

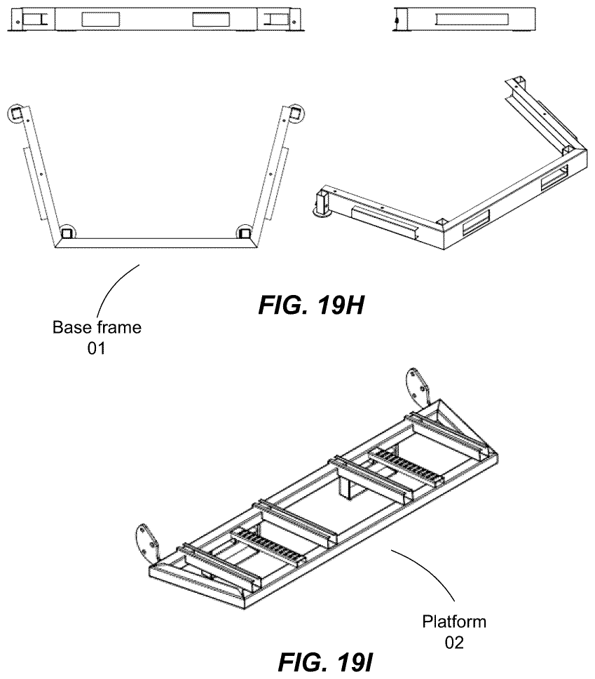

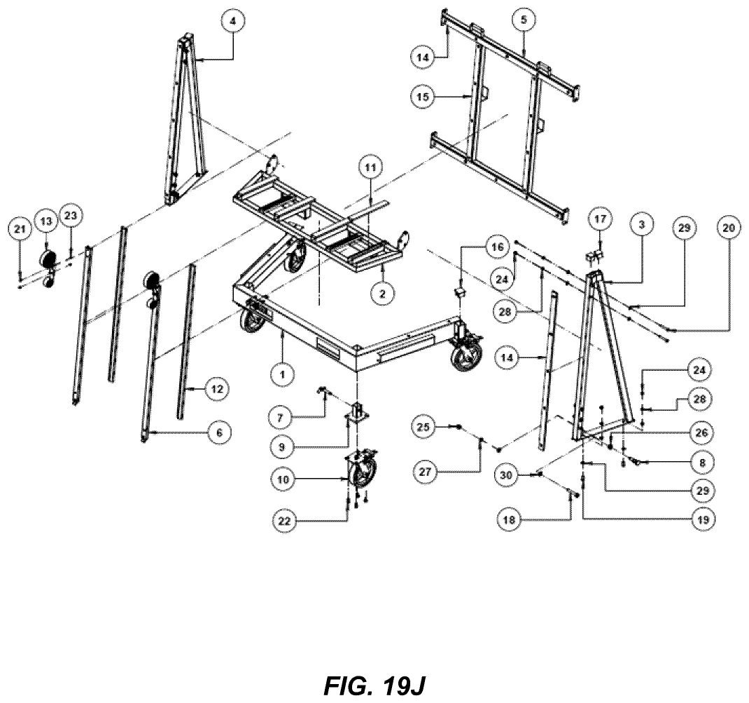

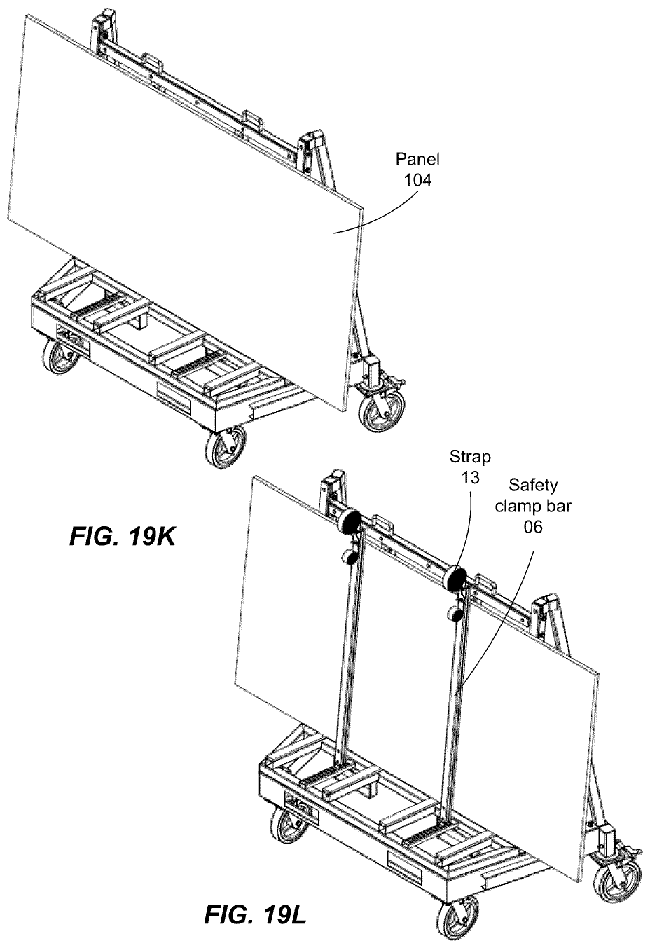

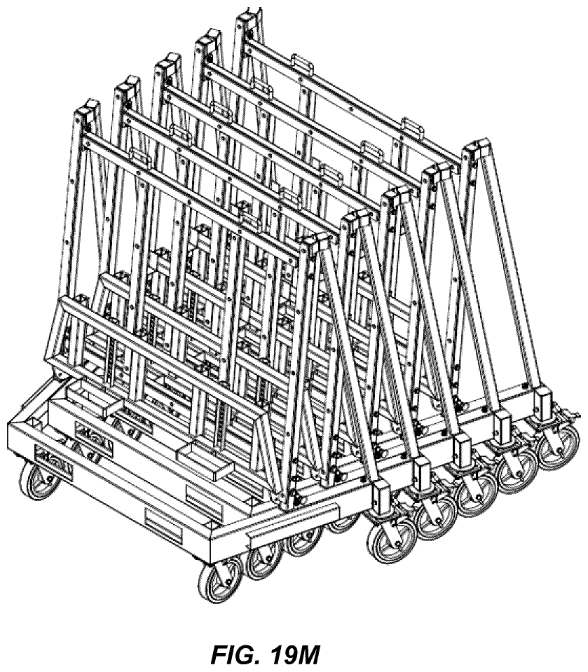

FIGS. 19A-19M illustrate configurations for push carts having a rotatable platform portion according to some embodiments. The push cart can be folded when not in use to save space when storing and transporting. For example, when not in use, the push carts can be folded together into a neat row, which does not taking up much space when storing. In addition, the push carts are also configured to accommodate fork lifts, such as having holes to accept the forks of a forklift.

The push cart can have a base frame (01), which has a trapezoid or quadrilateral shape. The base frame (01) can have a short side (01A) coupled to two lateral sides (01B). For example, the base frame includes V-shaped made of double-sided bent steel, and 4 corners with 4 holes for mounting a wheel assembly (09), The base frame includes a top portion with holes for mounting an A frame (04). The A frame is formed of a side beam (101A) of a load frame (101) and a side beam (102A) of a support frame (102). The side beams (101A) and (102A) are coupled at top ends to form the A frame. The load frame (101) is formed from 2 side beams (101A) and one or more cross beams (05). The support frame (102) is formed from 2 side beams (102A).

The front of the base frame has a forklift fork hole (103). There are 2 guide plates (104) on the side that help the bases to be stowed together easily.

The push cart can have a sub-base frame or platform (02), which also has a trapezoidal shape. The sub-base frame or platform has a top surface having load-bearing braces that are responsible for supporting the entire load of the material sheet, with a rubber buffer slot (11). The large bottom of the trapezoid has 2 rotating panels that help the sub-base or platform to be rotated up and down to create space when stacking 2 carts together.

The push cart can have A frames (03) and (04), formed from side beams of the load frame and the support frame: The A frame has a triangular shape, with the bottom edge being a flat plate with holes to fit into the base frame (01). The side has holes for mounting brackets or cross beams (05) and sub-base frame or platform (02). The front of the side edge has a rubber mount to support the material panels. These A frames create an inclined surface with the vertical on the load frame so that the sheet of material or panel does not fall back out.

The push cart can have a cross beams (05) forming a link frame assembly in the load frame. The link frame has the shape of a horizontal H. This frame is responsible for linking 2 A frames (03) and (04) together, forming the load frame at one side and the support frame at an opposite side. The load frame is formed from 2 bars of the A frames. The support frame is formed from 2 other bars of the A frames. At the same time, the front of the link frame also has a rubber mount that acts like a small sheet of material. The top has a U hook for hooking the safety clamp bar or clip bar (06). The back has a position for the safety clamp bar or clip bar to be secure when not in use.

The push cart can have a safety clamp bar (06), which can be a straight bar. An end of the safety clamp bas has a hook to insert into the grooves on the Sub-Base Frame or platform (02). The other end has a strap attached to hook it to the cross beam (05). There are grooves on the body to install rubber to avoid scratching the material plate when in use.

The push cart can have a cluster of auxiliary locking latches (08), which includes 3 parts. The top of the handle has a rounded edge for easy grip. The body is threaded on the outside, and the inside is hollow with a spring. The core part is a cylindrical pin. This pin will move out with manual pull and return by spring force, which is responsible for locking the auxiliary base, e.g., the A frame (03) through the holes on the swing arm of the platform for the platform to rotate.

The push cart can have a wheel assembly (09): The bottom is a rectangular base plate with wheel mounting holes. The top of the rectangular box has a hole for mounting the wheel pin (07), which is responsible for the connection between the wheel and the base frame (01). At the position of the latch hole, there is a semicircle to keep the latch from falling out when moving.

Wheel pin (07) are used to secure the wheel assembly to the base frame: The wheel pin has a round cylinder, with one end bent, and the other end beveled to easily pierce the wheel assembly hole. On the body is welded a semicircular plate that locks to keep the latch from slipping during movement.

The push cart can have other components such as wheels (10), rubber sole (11), rubber safety clamp (06), strap (13), rubber (14) on cross beam (05) and (15), and bolts, nuts, washers.

FIGS. 19A-19B show perspective views of a push cart with the platform (02) lowered and raised, respectively. When lowered, the platform rests on the base frame (01). When raised, the platform rests on cross beams 15 of the load frame. The platform is rotatably coupled to the side beams 101A of the load frame.

FIGS. 19C-19D show configurations of the locking latches for rotating the sub base frame or the platform (02). A rotatable mechanism is coupled between the platform and the side beams of the load frame for rotating the platform. The latch (08) can function to lock the platform into a raised position for storage.

FIGS. 19E-19G show different views of the push cart, including a front view, a side view, and a top view.

FIGS. 19H-19I show a trapezoid base frame (01) and a sub base frame (platform) (02).

FIG. 19J shows an exploded view of the push cart with labeled components. The components include nuts, bolts, washers, pins, caps (7), (8), (9), (16), (17), (18), (19), (20), (21), (22), (23), (24), (25), (26), (27), (28), (29), and (30).

FIGS. 19K-19L show a push cart with loaded panels (104), without strapping and with strapping using straps 13 with safety clamp bar 06.

FIG. 19M shows a stack of push carts with the sub base frame raised.

As shown in FIGS. 19A-19M, the push cart has a structure including 2 A-frames (03) and (04) attached to the base frame (01) through bolts (19) and nuts (24). To help secure the arms of the A frame, the two arms (which include a side beam of the load frame and a side beam of the support frame) are connected by a coupling (17) through bolt (20). The front of the A frame and the cross beams are fitted with a protective rubber layer to help prevent impact on the material sheets when in use. On the top cross beam (05), there are U hooks for hooking Safety clamps (06) to help fix the material sheets when moving.

The sub-base frame or platform (02) will be attached to the front edge of A frame (03) and (04) through bolts (18) and nuts (25). The bolt (18) is both a link and a pivot, helping the sub-base frame to rotate up and down when not in use, creating free space for the two cars to be easily stowed together. On the swivel part of the subframe or platform 02, there are holes for locking pins (08) to keep the platform in the desired positions.

Below the base frame (01) there are positions to install the wheel assembly (09) with wheels (10) through the pin (07). These wheels are easily removable with a latching style using semicircular hubs. The push carts also have safety clamps (06) to ensure that the material plates are not moved during the movement of the push carts.

In operation, the materials, e.g., the panels, are put on the push cart. The safety clamp bar and the belt are assembled to secure the panels. The push cart is rolled to a destination. At the destination, the safety assembly is removed, and the panels are moved to the new locations.

The sub base frame or platform is turned up by unscrew the locking pin for rotation. The push cart is arranged in correct location with s tack of other push carts.

The present push cart can present a useful solution for moving slabs within the workshop and at construction sites. Compact size and flexible movement make it more convenient during transportation. The V-shaped chassis design helps the car to be neatly stacked when not in use. The sub-base or platform can be rotated 90 degrees to reduce additional space when folded, with safety latches in positions.

In addition to the application of the palletized material trolley, it can also be combined with the forklift through holes designed to match the fork forks. The safety clamp system helps to ensure that the sheet of material does not move when moving. Wheels can be quickly removed via locking pins. The material plate contact positions all have a protective rubber layer to prevent scratches.

Advantages of the push carts include stacking in row with reduced storage space. The V-shaped body structure can be folded into rows. The sub-base can be rotated up and down, with latches to lock each position. The wheels have locking pins for quick disassembly. A safety strut system is included for securing transporting objects.

In some embodiments, the present invention discloses a stackable push cart with a multiple level platform.

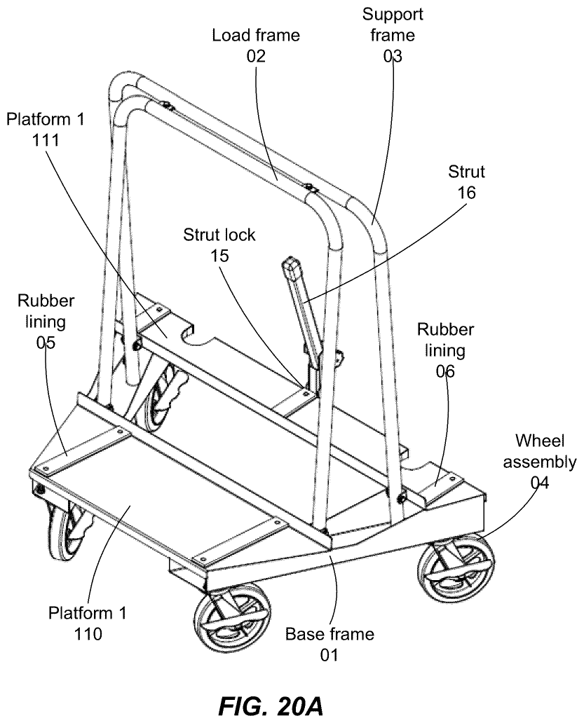

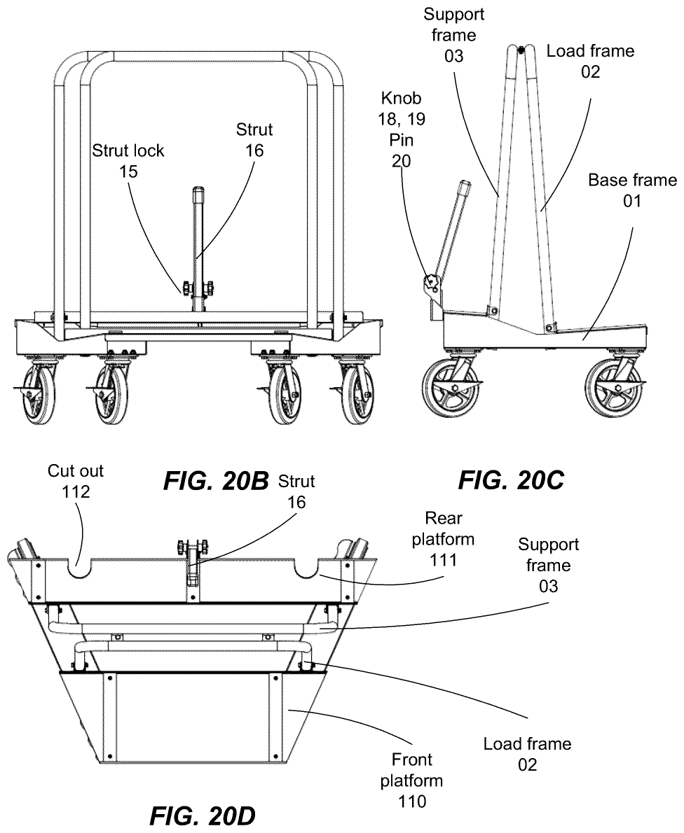

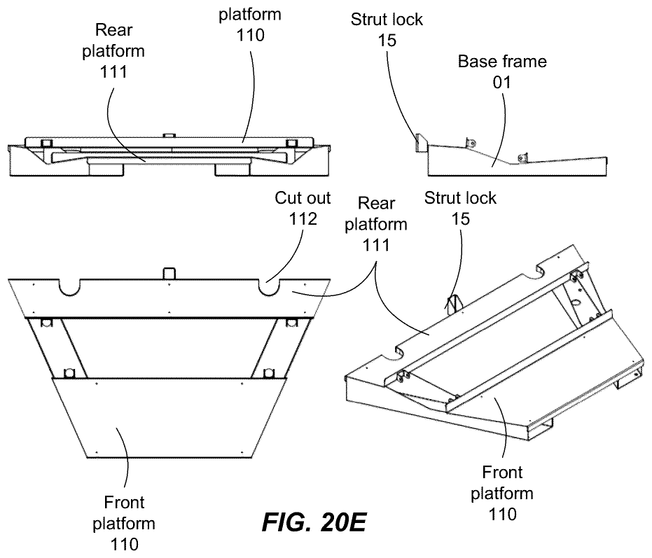

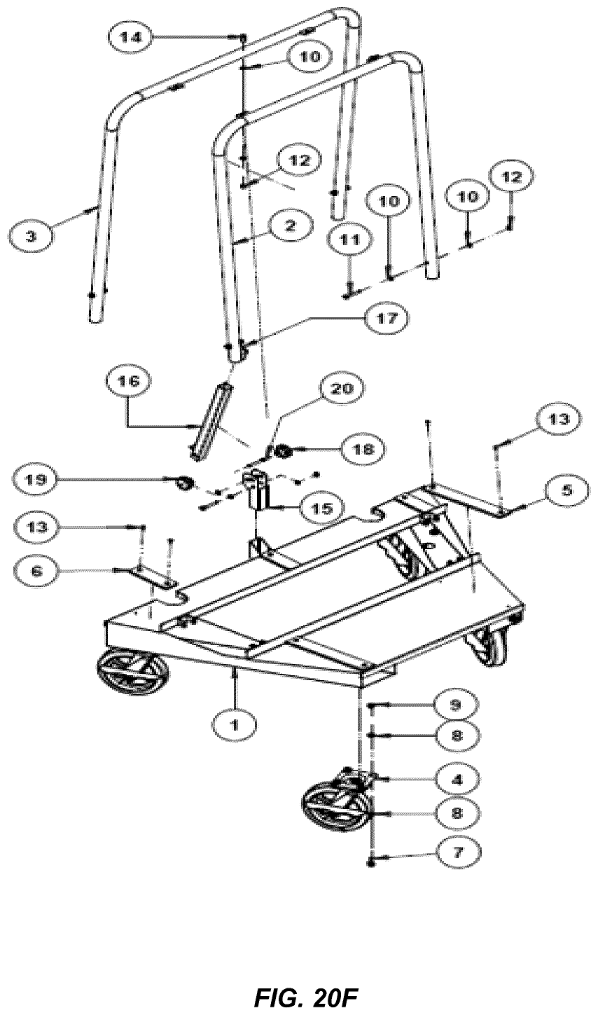

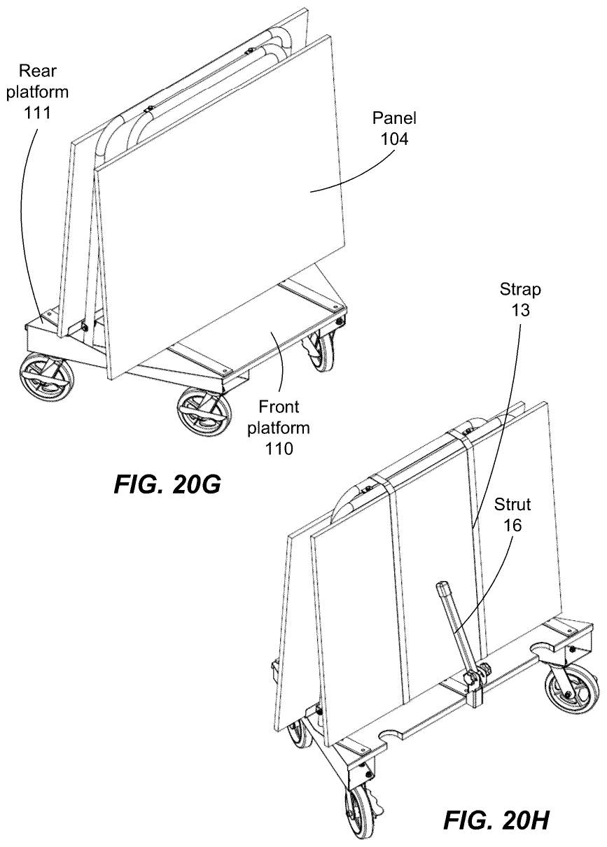

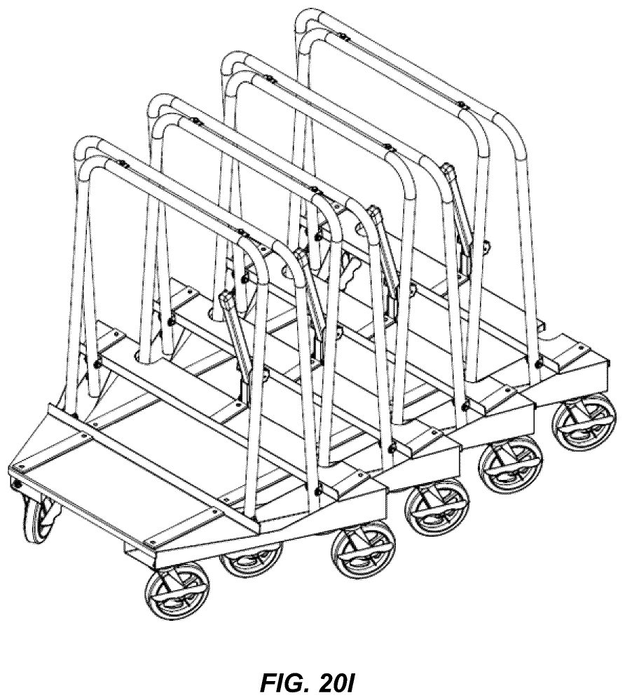

FIGS. 20A-20I illustrate configurations for push carts having a multi level platform according to some embodiments. The multi level platform can allow materials to be placed on both sides to help balance the push cart when moving. The materials can be secured with a handy safety system.

The push cart can include a base frame (01), which has a V-shaped made of double-sided bent steel, with 4 corners having holes for mounting wheel assemblies (04), The top has a front support platform 110 and a back support platform 111 in the front and rear. In the middle of the 2 support platforms, there is a position to install the front support U-frame or load frame (02) and the rear support U-frame or support frame (03). On the 2 support platforms, there are holes for installing rubber lining (05) and (06). On the back support platform 111, there is a U-patch welding to install the strut lock (15).

The push cart can include a U-frame (02) or a load frame for front panel support, for supporting panels loaded to the cart on the front platform 110: The load frame (02) can be formed from a round tube that is bent into a U-shaped to form the load frame. Alternatively, the load frame (02) can include two side beams coupled at the top by a top cross beam. The top cross beam of the load frame has a bracket to couple the load frame (02) to the support frame (03), e.g., to the rear support U frame. The bottom ends of the load frame have mounting holes for coupling to the base frame (01). The load frame can function to support the panels when the panels are placed on the front platform 110.

The push cart can include a rear support U-frame or support frame (03): The support frame (03) can be formed from a round tube that is bent into a U-shaped to form the support frame. Alternatively, the support frame (03) can include two side beams coupled at the top by a top cross beam. The U shape of the support beam can be larger than the U shape of the load frame (02). The top cross beam of the support frame has a bracket to couple the load frame (02) to the support frame (03). The bottom ends of the support frame have mounting holes for coupling to the base frame (01). The support frame can function to support the panels when the panels are placed on the rear platform 111.

The front and rear platform can be installed with rubber lining (05) (06), which has the form of a rectangular sheet with an inner steel core covered with rubber for supporting the panels with anti-slip and anti-scratch.

The push cart can include a strut lock (15), which includes a lock pad having the form of a U-shaped bending plate. One end of the strut lock (15) is attached to the base frame (01). The other end of the locking strut has a mounting hole for the strut (16), which is also the center of the groove to lock the strut in the required position.

The push cart can include a strut (16), which has the form of a square tube, with one end having a hole to fit into the strut lock (15), and the other end having a rubber cap to press into the panels. The strut is locked with a knob (18), (19) and a pin (20), which can do the job of keeping the stone slab from tilting outwards out of the support frame.

The push cart can include a knob and pin assembly (18), (19), (20), which has a round shape with anti-slip ribs for tightening the strut. Other components can include, such as wheels (04), pin (20) and bolts, nuts, washers (7), (8), (9), (10), (11), (12), (13).

FIG. 20A shows a perspective view of a push cart with a multi level platform. The push cart can have a base frame 01 with a lower level platform 1 110 and an upper level platform 2 111. Rubber lining 05 and 06 can be coupled to the platforms 110 and 111. The base frame can couple to wheel assemblies 04. Load frame 02 and support frame 03 are coupled to the base frame, for supporting panels on the platforms 110 and 111. A strut 16 installed into a strut lock 15 is used for holding panels on the platform 111 against the support frame 03.

FIGS. 20B-20D show different views of the push cart, including a front view, a side view, and a top view. The rear platform 111 includes cut outs 112, which match with the side beams of the load frame 03. The cut outs 112 are configured to shorten a distance along a stacking direction, in order to stack the push carts.

FIG. 20E shows different views of a multi level platform, including a base frame 01, a front platform 110 and a rear platform 111. Cut outs can be performed on the rear platform. Strut lock can be included on the base frame to accept a strut for holding the panels on the rear platform against the support frame.

FIG. 20F shows an exploded view of the push cart with labeled components.

FIGS. 20G-20H show a push cart with loaded panels 104, without strapping and with strapping 13. Strut 16 is also included for holding the panels on the rear platform

FIG. 20I shows a stack of push carts.

As shown in FIGS. 20A-20I, the push cart has a structure including a bottom base plate 01 has 4 wheels (04) which are installed to the Base Frame (01) through bolts (07), washers (08) and nuts (09). The top surface of the base frame has a front U frame (02) (the load frame) and a rear U frame (03) (the support frame), which are attached to the base frame with bolts (11), washers (10) and nuts (12). The top part of the two U-frames (the load and support frames) has a bracket for fastening together with bolts (14), washers (10) and nuts (12). Together the base frame 01, the load frame 02 and the support frame 03 form the main frame of the device. On the base frame (01) there are hole positions to install rubber pads to help prevent the panels from slipping and scratch.

In addition, there is also a safety strut assembly including a strut (16) attached to a strut lock (15) through the bolt (11), washer (10) and nut (12). This strut can be rotated to different angles and is tightened by the knob (18) through the tightening shaft (20). The entire assembly of these safety struts can be quickly mounted to the base at a pre-welded U-pattern position on the base frame (01).

In operation, the materials, e.g., the panels, are put on the push cart. The safety strut and the belt are fastened to secure the panels. The push cart is rolled to a destination. At the destination, the safety strut is removed, and the panels are moved to the new locations. The push cart is arranged in a neat array with other push carts.

Advantages of the push carts include the push carts can be folded into a row. The V-shaped body structure can be folded into rows. Fabrication of the push cart includes a quick assembly U-frame structure. The base frame has anti-slip and anti-scratch rubber plates. A safety strut system is included for securing transporting objects with quick installation.

What is claimed is:

1. A stackable cart for transporting panels, the stackable cart comprising
a base frame comprising an open quadrilateral shape,
wherein the open quadrilateral shape comprises a short side and two lateral sides without a fourth side, with the fourth side longer than the short side facing the long side,
wherein the open quadrilateral shape is configured for lateral stacking with a second open quadrilateral base frame of a second stackable cart in a stack direction perpendicular to the short side,
wherein the base frame is coupled to rotatable wheels at a front side toward the short side and at a rear side toward the long side of the open quadrilateral shape;
a load frame for side supporting the panels,
wherein the load frame comprises two upward first side beams and one or more cross beams coupled to the first side beams,
wherein the first side beams are coupled to the lateral sides of the open quadrilateral base frame,
wherein the cross beams are above and not in a volume defined by the base frame;
a support frame for supporting the load frame,
wherein the support frame comprises two upward second side beams,
wherein the second side beams are coupled to the lateral sides of the open quadrilateral base frame,
wherein the support frame is coupled to the load frame;
a platform for supporting the panels,
wherein the platform comprises a rotatable platform, a tilt platform, or a flat platform,
wherein the rotatable platform is configured to be rotated to an upward position,
wherein the tilt platform forms an angle with a horizontal direction or comprising a width configured to enable the stacking of the stackable cart,
wherein the flat platform comprises a width configured to enable the stacking of the stackable cart.

2. A stackable cart as in claim 1,
wherein the lateral stacking of the stackable cart and the second stackable cart comprises a stack period,
wherein the support frame comprises a top second cross beam,
wherein the top second cross beam is coupled to a top cross beam of the one or more cross beams of the load frame,
wherein coupling of the top second cross beam with the top cross beam comprises a distance along the stack direction to be less than the stack period.

3. A stackable cart as in claim 1,
wherein the lateral stacking of the stackable cart and the second stackable cart comprises a stack period,
wherein the load frame comprises a top cross beam among the one or more cross beams,
wherein the support frame comprises a top second cross beam,
wherein at least one of the upward first side beams or the upward second side beams are tilted toward the other side beams with the top cross beam coupled to the second top cross beam,
wherein coupling of the top second cross beam with the top cross beam comprises a distance along the stack direction to be less than the stack period.

4. A stackable cart as in claim 1,
wherein the two upward second side beams are coupled to the two upward first side beams at top portions.

5. A stackable cart as in claim 1,
wherein at least one of the upward first side beams or the upward second side beams are tilted toward the other side beams with each upward first and second side beam coupled together at a top portion.

6. A stackable cart as in claim 1,
wherein the lateral stacking of the stackable cart and the second stackable cart comprises a stack period,
wherein the support frame comprises a second cross beam,
wherein a spacing between each of the one or more first cross beams and the second cross beam is shorter than the stack period, with the spacing determined as a farthest distance between the two cross beams.

7. A stackable cart as in claim 1,
wherein the lateral stacking of the stackable cart and the second stackable cart comprises a stack period,
wherein the support frame comprises a second cross beam,
wherein a cross beam of the one or more first cross beams and the second cross beam closer to the short side is lower than another cross beam of the one or more first cross beams and the second cross beam, characterized by a highest point on the cross beam lower than a lowest point on the another cross beam.

8. A stackable cart as in claim 1,
wherein the load frame is positioned closer to the rear side of the base frame than the support frame,
wherein the second side beams of the support frame are coupled to a vicinity of the front side of the base frame.

9. A stackable cart as in claim 1,
wherein the support frame is also configured for supporting the panels,
wherein the first side beams of the load frame and the second side beams of the support frame are coupled to portions of the lateral sides between the front side and the rear side of the base frame.

10. A stackable cart as in claim 1,
wherein the load frame is positioned closer to the front side of the base frame than the support frame,
wherein the second side beams of the support frame are coupled to a vicinity of the rear side of the base frame.

11. A stackable cart for transporting panels, the stackable cart comprising
a base frame comprising an open quadrilateral shape,
wherein the open quadrilateral shape comprises a short side and two lateral sides without a fourth side, with the fourth side longer than the short side facing the long side,
wherein the open quadrilateral shape is configured for lateral stacking with a second open quadrilateral base frame of a second stackable cart,
wherein the base frame is coupled to rotatable wheels at a front side toward the short side and at a rear side toward the long side of the open quadrilateral shape;
a load frame for side supporting sides of the panels,
wherein the load frame comprises two upward first side beams and one or more cross beams coupled to the first side beams,
wherein the first side beams are coupled to the lateral sides of the open quadrilateral base frame,
wherein the cross beams are above and not in a volume defined by the base frame;
a support frame for supporting the load frame,
wherein the support frame comprises two upward second side beams,
wherein the second side beams are coupled to the lateral sides of the open quadrilateral base frame,
wherein the support frame is coupled to the load frame;
a rotatable platform for supporting edges of the panels,
wherein the rotatable platform is configured to rotate the platform to an upward position,
wherein the upward position is configured to enable the stacking of the stackable cart.

12. A stackable cart as in claim 11,
wherein the load frame is positioned closer to the front side of the base frame than the support frame,
wherein the second side beams of the support frame are coupled to a vicinity of the rear side of the base frame,
wherein the rotatable platform is rotatably coupled to the load frame or to the base frame to rotate between an operating configuration for supporting edges of the panels and a storage configuration for stacking the stackable cart,
wherein in the operating configuration, the rotatable platform is rested against the base frame,
wherein in the storage configuration, the rotatable platform is rested against the load frame.

13. A stackable cart as in claim 11,
wherein the support frame is also configured for supporting the panels,
wherein the first side beams of the load frame and the second side beams of the support frame are coupled to portions of the lateral sides between the front side and the rear side of the base frame,
wherein the rotatable platform is rotatably coupled to the load frame or to the base frame to rotate between an operating configuration for supporting edges of the panels and a storage configuration for stacking the stackable cart,
wherein in the operating configuration, the rotatable platform is rested against the base frame,
wherein in the storage configuration, the rotatable platform is rested against the load frame,
the stackable cart further comprising
a second platform for supporting the panels,
wherein the second platform is rotatably coupled to the support frame or to the base frame to rotate between the operating configuration for supporting edges of the panels and the storage configuration for stacking the stackable cart.

14. A stackable cart as in claim 11,
wherein the support frame is also configured for supporting the panels,
wherein the first side beams of the load frame and the second side beams of the support frame are coupled to portions of the lateral sides between the front side and the rear side of the base frame,
wherein the rotatable platform is rotatably coupled to the load frame or to the base frame to rotate between an operating configuration for supporting edges of the panels and a storage configuration for stacking the stackable cart,
wherein in the operating configuration, the rotatable platform is rested against the base frame,
wherein in the storage configuration, the rotatable platform is rested against the load frame,
the stackable cart further comprising
a second flat or tilted platform for supporting the panels,
wherein the second flat or tilted platform is tilted a second angle with the horizontal direction, with the second angle is larger than a threshold angle having a sine value equal to a ratio of a width of the second platform and a stack period of the lateral stacking of the stackable cart and the second stackable cart, or
wherein the second flat or tilted platform comprises a width less than the stack period.

15. A stackable cart as in claim 11,
wherein the load frame is positioned closer to the rear side of the base frame than the support frame,
wherein the second side beams of the support frame are coupled to a vicinity of the front side of the base frame,
wherein the rotatable platform is rotatably coupled to the load frame or to the base frame to rotate between an operating configuration for supporting edges of the panels and a storage configuration for stacking the stackable cart,
wherein in the operating configuration, the rotatable platform is rested against the base frame,
wherein in the storage configuration, the rotatable platform is rested against the load frame.

16. A stackable cart for transporting panels, the stackable cart comprising
a base frame comprising an open quadrilateral shape,
wherein the open quadrilateral shape comprises a short side and two lateral sides without a fourth side, with the fourth side longer than the short side facing the long side,
wherein the open quadrilateral shape is configured for lateral stacking with a second open quadrilateral base frame of a second stackable cart,
wherein the base frame is coupled to rotatable wheels at a front side toward the short side and at a rear side toward the long side of the open quadrilateral shape;
a load frame for side supporting sides of the panels,
wherein the load frame comprises two upward first side beams and one or more cross beams coupled to the first side beams,
wherein the first side beams are coupled to the lateral sides of the open quadrilateral base frame,
wherein the cross beams are above and not in a volume defined by the base frame;
a support frame for supporting the load frame,
wherein the support frame comprises two upward second side beams,
wherein the second side beams are coupled to the lateral sides of the open quadrilateral base frame,
wherein the support frame is coupled to the load frame;
a flat or tilted platform for supporting edges of the panels,
wherein a width or a tilted angle of the flat or tilted platform is configured to enable the stacking of the stackable cart.

17. A stackable cart as in claim 16,
wherein the load frame is positioned closer to the front side of the base frame than the support frame,
wherein the second side beams of the support frame are coupled to a vicinity of the rear side of the base frame,
wherein the flat or tilted platform is tilted a first angle with the horizontal direction, with the first angle larger than a threshold angle having a sine value equal to a ratio of a width of the tilt platform and a stack period of the lateral stacking of the stackable cart and the second stackable cart, or
wherein the flat or tilted platform comprises a width less than the stack period.

18. A stackable cart as in claim 16,
wherein the support frame is also configured for supporting the panels,
wherein the first side beams of the load frame and the second side beams of the support frame are coupled to portions of the lateral sides between the front side and the rear side of the base frame,
wherein the flat or tilted platform is tilted a first angle with the horizontal direction, with the first angle larger than a threshold angle having a sine value equal to a ratio of a width of the tilt platform and a stack period of the lateral stacking of the stackable cart and the second stackable cart, or
wherein the flat or tilted platform comprises a width less than the stack period, the stackable cart further comprising
a second platform for supporting the panels,
wherein the second platform is rotatably coupled to the support frame or to the base frame to rotate between an operating configuration for supporting edges of the panels and a storage configuration for stacking the stackable cart,
wherein in the operating configuration, the second platform is rested against the base frame,
wherein in the storage configuration, the second platform is rested against the load frame.

19. A stackable cart as in claim 16,
wherein the support frame is also configured for supporting the panels, wherein the first side beams of the load frame and the second side beams of the support frame are coupled to portions of the lateral sides between the front side and the rear side of the base frame,
wherein the flat or tilted platform is tilted a first angle with the horizontal direction, with the first angle larger than a threshold angle having a sine value equal to a ratio of a width of the tilt platform and a stack period of the lateral stacking of the stackable cart and the second stackable cart, or
wherein the flat or tilted platform comprises a width less than the stack period,
the stackable cart further comprising
a second flat or tilted platform for supporting the panels,
wherein the second flat or tilted platform is tilted a second angle with the horizontal direction, with the second angle is larger than a threshold angle having a sine value equal to a ratio of a width of the second platform and a stack period of the lateral stacking of the stackable cart and the second stackable cart, or
wherein the second flat or tilted platform comprises a width less than the stack period.

20. A stackable cart as in claim 16,
wherein the load frame is positioned closer to the rear side of the base frame than the support frame,
wherein the second side beams of the support frame are coupled to a vicinity of the front side of the base frame,
wherein the flat or tilted platform is tilted a first angle with the horizontal direction, with the first angle larger than a threshold angle having a sine value equal to a ratio of a width of the tilt platform and a stack period of the lateral stacking of the stackable cart and the second stackable cart, or
wherein the flat or tilted platform comprises a width less than the stack period.
